(19) United States
(12) Patent Application Publication
(10) Pub. No.: US 2026/0312615 A1
(43) Pub. Date: Oct. 8, 2026

(54) FLEXIBLE COMMUNICATION ARCHITECTURES AND TECHNIQUES FOR MEDIA PLAYBACK SYSTEMS

(71) Applicant: Sonos, Inc., Goleta, CA (US)

(72) Inventors: Jeffrey Peters, Cambridge, MA (US); Nicholas A.J. Millington, Santa Barbara, CA (US); Tarangkumar Darshikbhai Shah, Goleta, CA (US); Michael Frey, Tyngsboro, MA (US); Hrishikesh Gossain, Santa Barbara, CA (US)

(21) Appl. No.: 19/491,458

(22) PCT Filed: Jun. 7, 2024
(86) PCT No.: PCT/US2024/032937

§ 371 Date: Dec. 9, 2025

Related U.S. Application Data
(60) Provisional application No. 63/507,162, filed on Jun. 9, 2023.
(60) Provisional application No. 63/586,259, filed on Sep. 28, 2023.
(60) Provisional application No. 63/586,262, filed on Sep. 28, 2023.
(60) Provisional application No. 63/586,264, filed on Sep. 28, 2023.
(60) Provisional application No. 63/554,561, filed on Feb. 16, 2024.

(51) Int. Cl. H04B 1/401; H04B 1/00

(52) U.S. Cl. CPC H04B 1/401; H04B 1/006

(57) ABSTRACT

Flexible communication architectures and techniques for media playback systems. An example wireless communication interface includes a radio IC including a first radio and a second radio, each configured to support wireless communications in a plurality of frequency ranges, and RF front-end circuitry coupled to the radio IC and configured to selectively couple each of the first and second radios to a respective antenna terminal to establish a first transceiver chain for a first operating frequency range between the first radio and a first antenna terminal and a second transceiver chain for a second operating frequency range between the second radio and a second antenna terminal, wherein the first and second operating frequency ranges are non-overlapping. In some examples, the plurality of frequency ranges comprises non-overlapping first and second portions of a 5 GHz band, and a 6 GHz band, all in 802.11-based protocols.

### CROSS-REFERENCE TO RELATED APPLICATIONS

This application claims priority to co-pending U.S. Provisional Application Nos. 63/507,162 filed on Jun. 9, 2023, 63/586,259 filed on Sep. 28, 2023, 63/586,262 filed on Sep. 28, 2023, 63/586,264 filed on Sep. 28, 2023, and 63/554,561 filed on Feb. 16, 2024, each of which is hereby incorporated herein by reference in its entirety for all purposes.

### FIELD OF THE DISCLOSURE

The present disclosure is related to consumer goods and, more particularly, to methods, systems, products, aspects, services, and other elements directed to media playback or some aspect thereof.

### BACKGROUND

Options for accessing and listening to digital audio in an out-loud setting were limited until in 2002 when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Aspects, and advantages of the presently disclosed technology may be better understood with regard to the following description, appended claims, and accompanying drawings, as listed below. A person skilled in the relevant art will understand that the elements shown in the drawings are for purposes of illustrations, and variations, including different and/or additional elements and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks, in accordance with an example.

FIG. 1C is a block diagram of a playback device, in accordance with an example.

FIG. 1D is a block diagram of a playback device, in accordance with an example.

FIG. 1E is a block diagram of a bonded playback device, in accordance with an example.

FIG. 1F is a block diagram of a network microphone device, in accordance with an example.

FIG. 1G is a block diagram of a playback device, in accordance with an example.

FIG. 1H is a partial schematic diagram of a control device, in accordance with an example.

FIGS. 1I through 1L are schematic diagrams of corresponding media playback system zones, in accordance with an example.

FIG. 1M is a schematic diagram of media playback system areas, in accordance with an example.

FIG. 2A is a block diagram illustrating a home theater environment, in accordance with an example.

FIG. 2B is a block diagram illustrating a home theater environment, in accordance with another example.

FIG. 3A is a diagram illustrating a methodology that can be utilized by a primary device to communicate audio content to a satellite device in a home theater environment, in accordance with an example.

FIG. 3B is a diagram illustrating another methodology that can be utilized by a primary device to communicate audio content to a satellite device in a home theater environment, in accordance with an example.

FIG. 4A is a logical diagram of a wireless communication interface for a primary device, in accordance with an example.

FIG. 4B is a logical diagram of a wireless communication interface for a primary device, in accordance with another example.

FIG. 5A is a detailed logical diagram depicting an implementation of a wireless communication interface, in accordance with an example.

FIG. 5B is a detailed logical diagram depicting another implementation of a wireless communication interface, in accordance with an example.

FIG. 5C is a detailed logical diagram depicting another implementation of a wireless communication interface, in accordance with an example.

FIG. 6A is a circuit diagram depicting an implementation of aspects of a wireless communication interface, in accordance with an example.

FIG. 6B is a circuit diagram depicting another implementation of aspects of a wireless communication interface, in accordance with another example.

FIG. 6C is a circuit diagram depicting another implementation of aspects of a wireless communication interface, in accordance with another example.

FIG. 6D is a circuit diagram depicting another implementation of aspects of a wireless communication interface, in accordance with another example.

FIG. 6E is a circuit diagram depicting another implementation of aspects of a wireless communication interface, in accordance with another example.

FIG. 6F is a circuit diagram depicting another implementation of aspects of a wireless communication interface, in accordance with another example.

FIG. 7A is a flow diagram illustrating a method of operation, in accordance with an example.

FIG. 7B is a flow diagram illustrating a method of operation, in accordance with another example.

FIG. 8 is a sequence diagram illustrating a method of operation, in accordance with an example.

FIG. 9 is a sequence diagram illustrating a method of operation, in accordance with an example.

FIG. 10 is a diagram illustrating a network protocol stack including a switch for performing radio role switching in accordance with an example.

FIG. 11 is a diagram of one example of switch control circuitry that may be used with the circuitry of FIG. 6F in accordance with an example.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Systems and techniques disclosed herein relate to providing flexible communication architectures and methods for media content playback devices, such as may be used in home theater and other applications.

In various instances and applications, including in home theater environments, it may be desirable to implement a low-latency communication scheme for wireless transmission of audio from a primary device (e.g., a soundbar) to one or more satellite devices (e.g., a subwoofer, a rear surround, etc.). Low-latency communication of audio enables expeditious transmission of audio content received at the primary device from a television to the one or more satellite devices for playback within a short period of time (e.g., within tens of milliseconds) after receipt. Such expeditious transmission of the received audio allows the home theater system to render the received audio in lip-synchrony with the corresponding visual content displayed on the television. Should the transmission of audio content from the primary device to the one or more satellite devices take too long, the audio content associated with a given section of visual content may not reach the satellite devices in time to be rendered in lip-synchrony with the visual content (e.g., reaching the one or more satellite devices more than 40 milliseconds after the visual content has been rendered).

In such a low-latency communication scheme, the satellite devices may connect to a dedicated wireless network established by the primary device for communication of audio for playback. By employing a dedicated network established by the primary device to communicate the audio traffic to the satellite devices, the audio traffic may be communicated directly to the satellite devices without the delay otherwise introduced by an intermediate hop across an Access Point (AP) (or other piece of networking equipment). To enable such a dedicated network for transmission of audio content from the primary device to the satellite devices, the primary device may employ a communication system that is capable of both establishing the dedicated network for the satellite devices via a “fronthaul” connection and communicating over a “backhaul” connection to an AP (e.g., a user's AP in their home) so as to provide a communication path to other devices (e.g., user devices to facilitate control of the home theater system and/or cloud server(s) to obtain audio content for streaming). The low-latency audio communication enabled by the use of dedicated fronthaul and backhaul connections may form the basis for a range of high-value experiences for end-users, such as achieving lip-synchronous playback of television audio and improved playback reliability of synchronous playback of high-quality audio formats (e.g., DOLBY ATMOS music) with large file sizes that may otherwise clog-up a user's home AP.

In some implementations, a primary device can incorporate multiple separate communication systems/interfaces, including one dedicated to the fronthaul connection and another dedicated to the backhaul connection. Each communication interface may include its own separate radio integrated circuits (ICs), front-end circuitry, and/or antennas. However, this approach may be prohibitively expensive for certain products, such as for lower-cost products and/or for products with otherwise compressed margins due to a high Bill-of-Materials (BOM) cost.

Accordingly, aspects of the present disclosure relate to communication architectures that combine various aspects of multiple communication systems to reduce the cost and complexity of implementation. Such communication architectures with a reduced cost and complexity may facilitate integration into less expensive products to bring high-value experiences (e.g., lip-synchronous playback of television audio, high reliability playback of complex audio formats, etc.) to a wider range of products. In some examples, the reduction in cost and complexity may be achieved, in part, by taking advantage of one or more characteristics of the communication systems whose functionality is being (at least partially) combined. For instance, in the context of low-latency audio transmission, a wireless channel employed for the backhaul connection to the AP by a first radio may always be in a different frequency band or sub-band than the wireless channel used for the dedicated wireless network for communication of audio to satellites by a second radio. In some examples, the two different frequency bands are selected from among the 2.4 GHz band, the 5 GHz band and 6 GHz band. Different sub-bands may include a first portion of the 5 GHz band (e.g., bottom half of the wireless channels) and a second portion of the 5 GHz band that is non-overlapping with the first portion (e.g., top half of the wireless channels), for example. As a result, in certain examples, some combinations of frequency bands and/or sub-bands are not used simultaneously. For example, the system can be configured such that the backhaul connection to the AP will not be in a wireless channel in the 6 GHz band while the dedicated wireless network is also operating on a wireless channel in the 6 GHz band. This allows certain components, such as an expensive bandpass filter for a given frequency band and/or sub-band, to be re-used between the fronthaul and backhaul radios.

As noted above, cost-savings can be achieved by re-using components in the signal path of multiple radios that will not be used at the same time (e.g., because the system can be configured such that the radios do not communicate in a channel in the same band or sub-band at the same time). In addition, cost-savings may also be achieved by designing the front-end circuitry associated with each of the two radios to only communicate over a subset of the possible frequency bands and/or sub-bands and enabling the two radios to switch roles. For instance, consider a scheme with four bands and/or sub-bands (e.g., 2.4 GHz, first 5 GHz sub-band, second 5 GHz sub-band, and 6 GHz band). Under this scheme the front-end circuitry coupled to the first radio may only enable a first subset of the three possible bands or sub-bands (e.g., 2.4 GHz, the first 5 GHz sub-band, and the 6 GHz band) and the front-end circuitry coupled to the second radio may only enable a second subset of the three possible bands or sub-bands that is different from the first subset (e.g., the second 5 GHz sub-band and the 6 GHz band). In a situation where a first radio is connected to a wireless network that is going to change a channel of operation from a first channel that is within the subset of frequency bands and/or sub-bands associated with the first radio to a second channel that is within the subset of frequency bands and/or sub-bands associated with a second radio, the role of the first and second radios may be switched such that the connection to the wireless network is transitioned from the first radio to the second radio. Given the ability for the roles of the radios to be switched as needed, the front-end circuitry for each of the radios may be simplified (e.g., constructed with fewer components that only support a subset of the possible frequency bands and/or sub-bands) that results in a cost savings.

The process of switching/transitioning roles of the first and second radios may be performed in any of a variety of ways. In some instances, the first and second radios may be integrated into a wireless communication interface that has multiple sets of one or more parameters that can be dynamically associated with and/or assigned to the first and second radios. The one or more parameters may include, for example, one or more of a Media Access Control (MAC) address, Internet Protocol (IP) address, Service Set Identifier (SSID), and/or Basic Service Set Identifier (BSSID). During a role transition between the radios, the wireless communication interface may cause a first set of parameters associated with a first radio to be switched with a second set of parameters (e.g., that were associated with a second radio). Accordingly, the role switch may, in some instances, be transparent to other devices that are communicating with the wireless communication interface at least because the one or more parameters remained unchanged (e.g., the MAC address, IP address, SSID, and/or BSSID have not changed).

According to some embodiments, a playback device comprises a wireless communication interface including a plurality of antennas, a radio integrated circuit (IC), and radio frequency (RF) front-end circuitry coupled to the radio IC and to the plurality of antennas. The radio IC includes a first radio configured to operate in a plurality of first frequency ranges and a second radio configured to operate in a plurality of second frequency ranges, wherein the plurality of first frequency ranges and the plurality of second frequency ranges share at least one common frequency range, and wherein at least one of the plurality of second frequency ranges is a frequency range that is non-overlapping with any of the plurality of first frequency ranges. The RF front-end circuitry can be configured to selectively couple a respective one or more antennas of the plurality of antennas to each of the first and second radios to establish at least one first transceiver chain between the first radio and the respective one or more antennas and at least one second transceiver chain between the second radio and the respective one or more antennas. In some examples, the playback device further comprises at least one processor and at least one non-transitory computer-readable storage medium coupled to the at least one processor and storing program instructions that are executable by the at least one processor to cause the playback device to receive from an external device, via the wireless communication interface, an audio stream representing audio content, and transmit to at least one other playback device, via the wireless communication interface, data representing at least one audio channel of the audio content.

According to some embodiments, a playback device comprises a wireless communication interface including a plurality of antennas, a radio integrated circuit (IC) including a first radio and a second radio, and radio frequency (RF) front-end circuitry coupled to the radio IC and to the plurality of antennas. Each of the first and second radios are configured to operate in a plurality of frequency ranges. The RF front-end circuitry is configured to selectively couple a respective one or more antennas of the plurality of antennas to each of the first and second radios to establish at least one first transceiver chain between the first radio and the respective one or more antennas and at least one second transceiver chain between the second radio and the respective one or more antennas, wherein the at least one first transceiver chain is configured for a first operating frequency range selected from the plurality of frequency ranges, wherein the at least one second transceiver chain is configured for a second operating frequency range selected from the plurality of frequency ranges, and wherein the first and second operating frequency ranges are non-overlapping. The playback device further comprises at least one processor and at least one non-transitory computer-readable storage medium coupled to the at least one processor and storing program instructions that are executable by the at least one processor to cause the playback device to after receiving, via the first radio, audio content from an external device, transmit to at least one other playback device, via the second radio, data representing at least one audio channel of the audio content.

According to some embodiments, a playback device comprises at least one processor and at least one wireless communication interface configured to facilitate communication over a plurality of frequency ranges, the at least one wireless communication interface comprising a first radio and a second radio. The playback device may further comprise at least one non-transitory computer-readable medium storing program instructions that are executable by the at least one processor such that the playback device is configured to establish, using the first radio, a connection to at least one external device, and establish a wireless network using the second radio. The playback device can further be configured to, after detecting that one or more other playback devices have connected to the wireless network, (i) receive first audio content, and (ii) communicate one or more audio channels of the first audio content to the one or more other playback devices over the wireless network using the second radio. The playback device may further be configured to detect an event, and based on the event, switch a role of the first radio with a role of the second radio such that the connection to the at least one external device is transitioned from the first radio to the second radio and the wireless network is transitioned from the second radio to the first radio.

Additional embodiments are directed to methods of operation for a playback device. In some examples, a method comprises establishing, using a first radio of the playback device, a connection to at least one external device using a wireless channel of operation within a first frequency range of a plurality of frequency ranges, detecting an instruction to initiate playback of audio content by at least one other playback device, after detecting the instruction, scanning the plurality of frequency ranges to identify a preferred frequency range from among the plurality of frequency ranges, and based on the preferred frequency range being the first frequency range, transmitting, from the playback device, a request to the at least one external device to change the wireless channel of operation. The method may further comprise, based on a response from the at least one external device, establishing, using a second radio of the playback device, a wireless network within one of the first frequency range or another frequency range from among the plurality of frequency ranges, and after detecting that the at least one other playback device has connected to the wireless network, (i) receiving, at the playback device, audio content from the at least one external device using the first radio, and (ii) communicating, from the playback device, one or more audio channels of the audio content to the at least one other playback device over the wireless network using the second radio.

The technology described herein to reduce the cost and complexity of implementing complex communication schemes (e.g., to enable additional functionality such as low-latency audio communication capabilities) may be readily applied to any of a variety of devices and is not limited to primary devices in a home theater system. For instance, the techniques described herein may be readily applied to mesh router systems where a given mesh router in the system may need to successfully coordinate a backhaul connection to a primary mesh router (e.g., the mesh router with a wired connection to a modem) within a wireless network established for one or more client devices to connect to. Further, the techniques described herein may be employed by devices that combine the functionality of a mesh router with a playback device (e.g., operating as a primary device in a home theater system). Accordingly, the disclosure is not limited in this respect.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

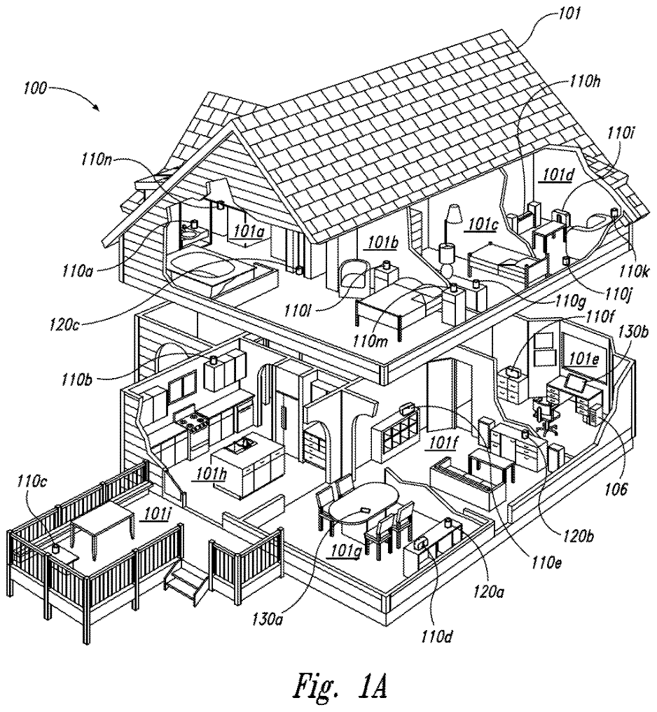

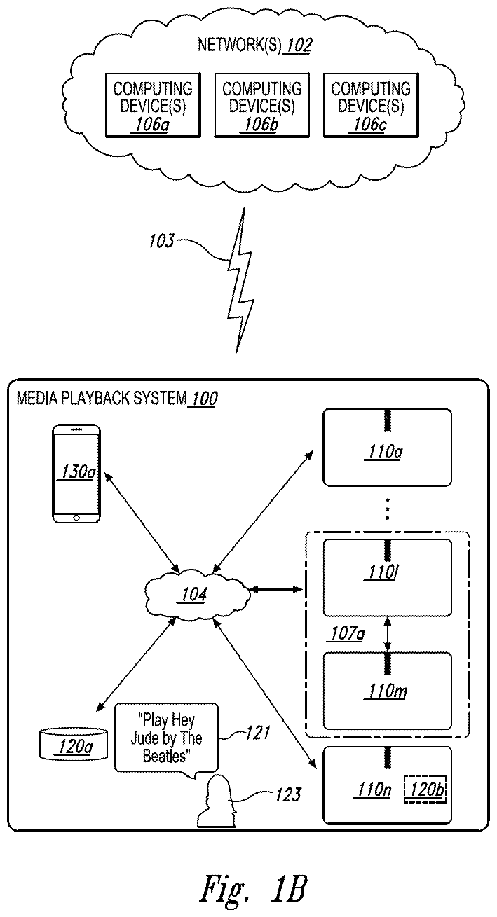

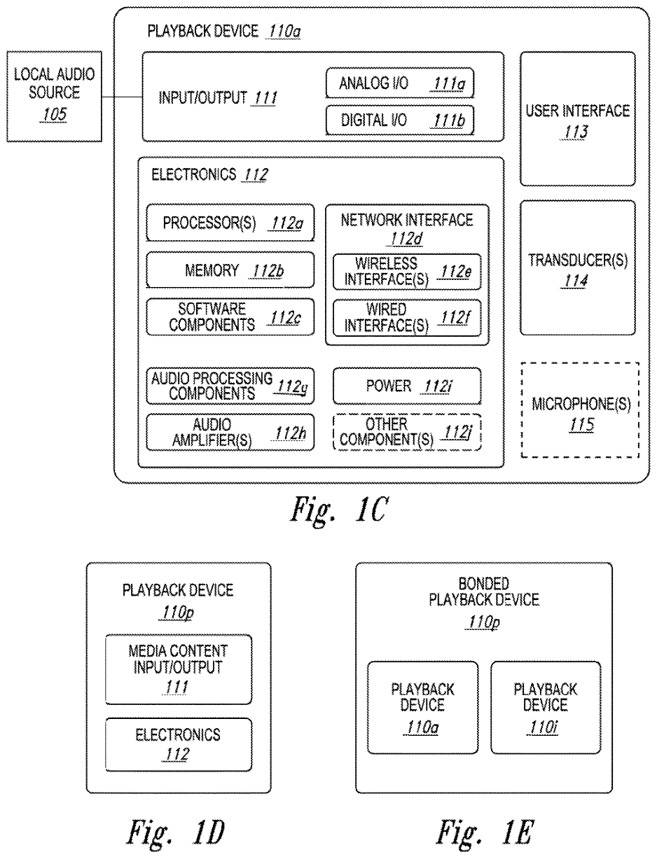

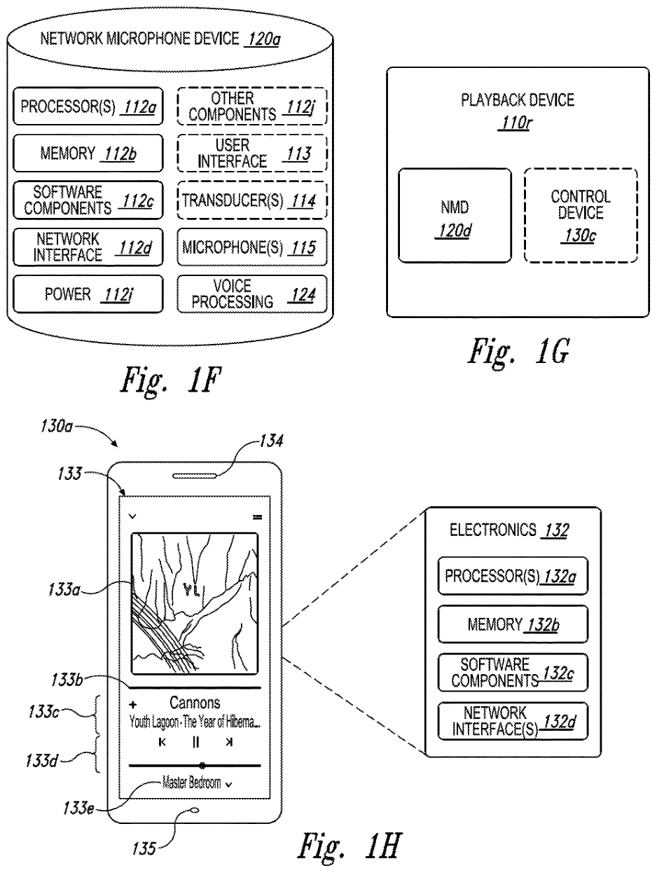

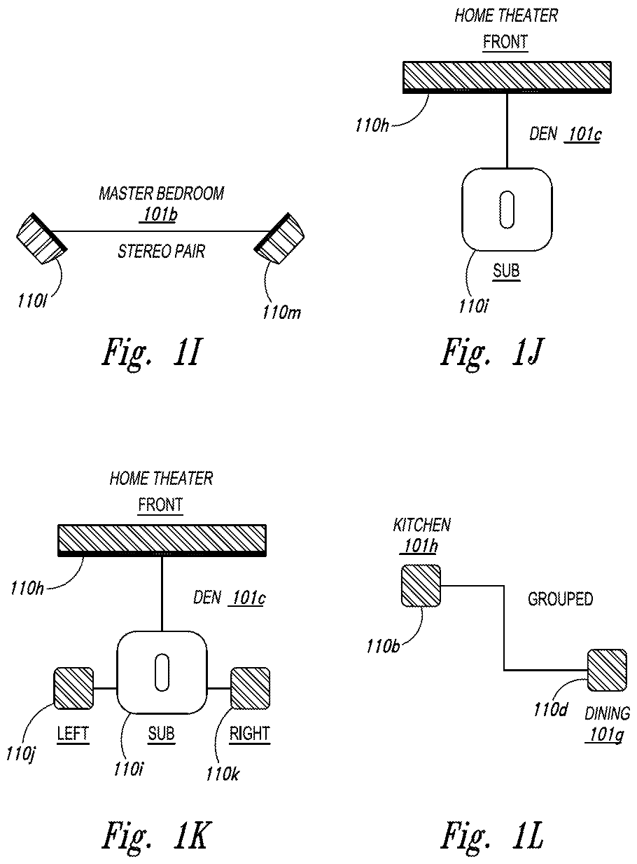

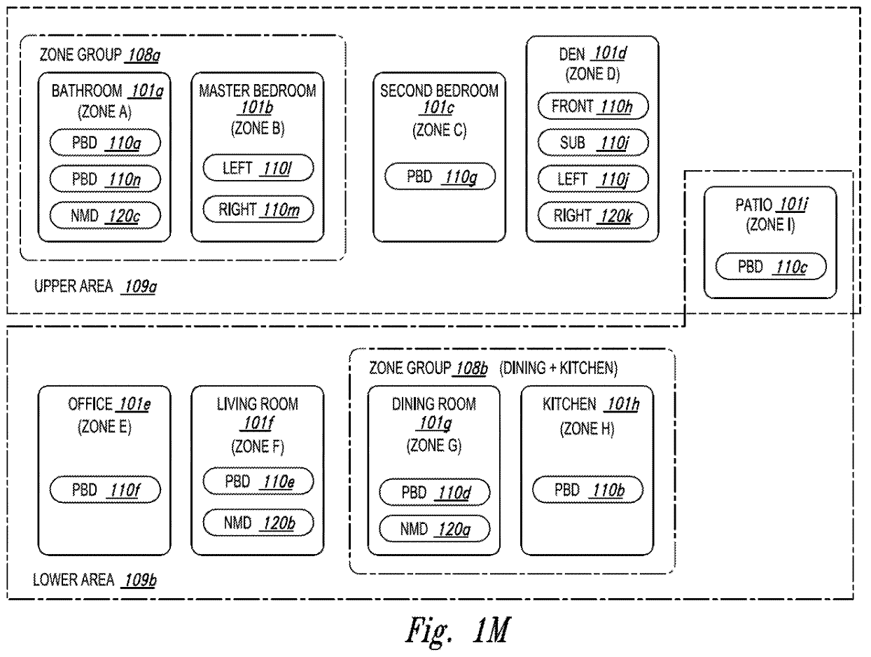

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and/or other aspects shown in the Figures are merely illustrative of particular embodiments of the disclosed technology. Accordingly, other embodiments can have other details, dimensions, angles, and aspects without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-1M.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments, the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110 and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100. In some aspects, for example, the computing device 106c comprises one or more modules and/or servers of a VAS (e.g., a VAS operated by one or more of SONOS, AMAZON, GOOGLE APPLE, MICROSOFT, etc.). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which is incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers.

Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low-frequency transducers (e.g., subwoofers, woofers), mid-range frequency transducers (e.g., mid-range transducers, mid-woofers), and one or more high-frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high-frequency audio content, and the playback device 110i is a subwoofer configured to render low-frequency audio content. In some aspects, the playback device 110a, when bonded with the first playback device, is configured to render only the mid-range and high-frequency components of particular audio content, while the playback device 110i renders the low-frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other attributes, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, 5G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone, and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate ‘control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments, the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies, and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in U.S. Pat. No. 10,499,146 filed on Feb. 21, 2017 and titled “Voice control of a media playback system.”

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group.

Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Home Theater Environments

As noted above, playback devices that are bonded may have different playback responsibilities, such as responsibilities for certain audio channels. For example, as illustrated in FIG. 1K, in a home theater environment, the Front and SUB devices 110h and 110i can be bonded with Left and Right playback devices 110j and 110k, respectively. Further, in some implementations, the Right and Left devices 110j and 110k can be configured to form surround or “satellite” channels of a home theater system. The bonded playback devices 110h, 110i, 110j, and 110k may form a single Zone D (FIG. 1M).

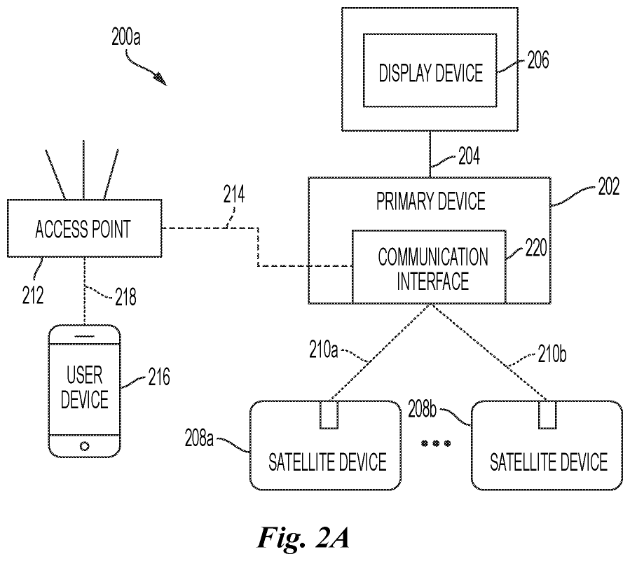

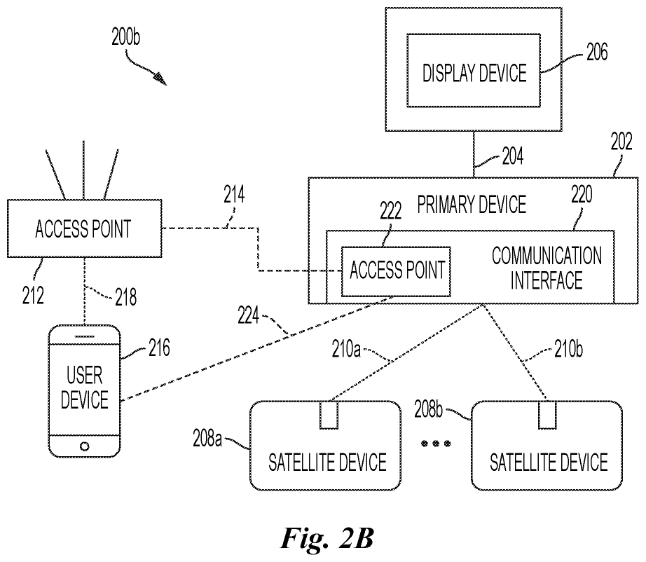

FIG. 2A illustrates an example of a home theater environment 200a. As shown, the home theater environment 200a comprises a primary device 202 that is coupled via a communication link 204 to a display device 206. The display device 206 may be any device, such as a television or monitor, for example, that displays visual content and outputs audio content (associated with the displayed visual content) via the communication link 204 to the primary device 202 (e.g., a soundbar, a smart TV box, a smart TV stick, etc.). The primary device 202 includes a wireless communication interface 220 used to communicate with one or more satellite devices 208 (shown as satellite devices 208a and 208b) via one or more communication links 210 (shown as communication links 210a and 210b). Additionally, the primary device 202 uses the wireless communication interface 220 to communicate with an access point (AP) 212 via a communication link 214 (e.g., a backhaul connection). The AP 212, in turn, communicates with other devices such as a user device 216 (e.g., a smartphone, tablet, laptop, desktop computer, etc.) via communication link 218. In some examples, the primary device 202 may be integrated with the display device 206, for example a TV may include a smart soundbar.

In some instances, the home theater environment 200a may playback audio from a music streaming service. In such instances, the primary device 202 may communicate with one or more cloud servers associated with a music service provider (e.g., via the communication link 214 to the AP 212) to obtain the audio content for playback. After receipt of the audio content for playback, the primary device 202 may communicate the audio content (or any portion thereof) to the satellite devices 208 for synchronous playback via the communication links 210. In examples where the primary device 202 is implemented as a soundbar (or otherwise comprises transducers for rendering audio content), the primary device 202 may render the audio content in synchrony with the satellite devices 208. In examples where the primary device 202 is implemented as a smart TV box or smart TV stick (or otherwise does not comprise transducers for rendering audio content), the satellite devices 208 may render the audio content in synchrony with each other while the primary device 202 may not render the audio content.

In some instances, the primary device 202 and the satellite devices 208 may render audio content in lip-synchrony with associated visual content displayed by the display device 206. In such examples, the primary device 202 may receive audio content from the display device 206. For example, the primary device 202 and the display device 206 can include analog and/or digital interfaces that facilitate communicating the audio content (e.g., multi-channel audio content) such as a SPDIF RCA interface, an HDMI interface (e.g., audio return channel (ARC) HDMI interface), an optical interface (e.g., TOSLINK interface), etc. In such examples, the communication link 204 may comprise a wired connection (e.g., an SPDIF cable, an HDMI cable, a TOSLINK cable, etc.). In other examples, the primary device 202 and the display device 206 may include wireless circuitry that facilitates wirelessly communicating the audio content from the display device 206 to the primary device 202. In such examples, the communication link 204 may be a wireless communication link such as a WI-FI link, BLUETOOTH link, ZIGBEE link, Z-WAVE link, and/or wireless HDMI link. In some examples, in the primary device 202, the wireless circuitry associated with the communication link 204 may be implemented in whole or in part as part of the wireless communication interface 220. In other examples, the wireless circuitry associated with the communication link 204 may be implemented separate from the wireless communication interface 220.

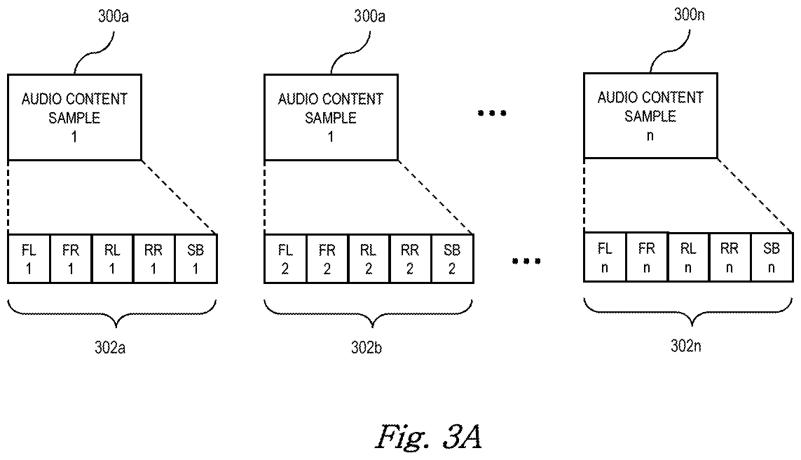

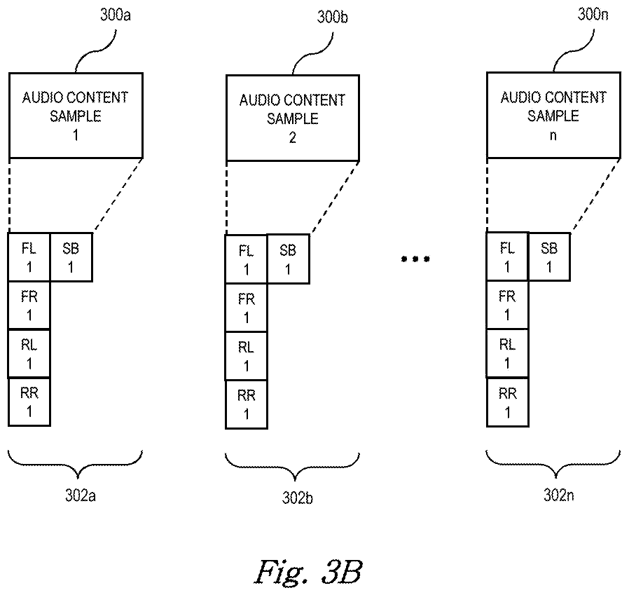

After receipt of the audio content associated with visual content to be rendered by the display device 206, the primary device 202 may communicate the received audio content (or any portion thereof) to the satellite devices 208 (e.g., via communication links 210). Any of a variety of methodologies may be employed to communicate the audio content to the satellite devices as described in more detail below with respect to FIGS. 3A and 3B. Once the audio content has been communicated to the satellite devices, the satellite devices 208 (and/or primary device 202) may render the audio content in synchrony with each other and in lip-synchrony with visual content displayed on the display device 206. For instance, in examples where the primary device 202 is implemented as a soundbar (or otherwise comprises transducers for rendering audio content), the primary device 202 may render the audio content in synchrony with the satellite devices 208 and in lip-synchrony with the visual content displayed on the display device 206. In examples where the primary device 202 is implemented as a smart TV box or smart TV stick (or otherwise does not comprise transducers for rendering audio content), the satellite devices 208 may render the audio content in synchrony with each other and in lip-synchrony with the display of visual content on the display device 206 while the primary device 202 may not render the audio content.

In some embodiments, the primary device 202 may also be configured to operate as an AP and/or as a router (e.g., a mesh router) that client devices (e.g., separate and apart from devices in the home theater environment) may be able to connect to for network access (e.g., access to a Wide Area Network (WAN) such as the Internet). For instance, the primary device 202 may be configured as a wireless mesh router that integrates into a mesh router system to extend the range of the mesh router system. Such mesh router systems are becoming increasingly advantageous with the deployment of countless Internet-of-Things (IoT) devices in spaces (e.g., residential and/or commercial spaces).

FIG. 2B illustrates an example of a home theater environment 200b comprising such a primary device 202 that is configured as a wireless mesh router. Relative to FIG. 2A, the primary device 202 further includes an AP 222 configured to extend the wireless network of the AP 212. In some examples, the AP 222 is implemented, in whole or in part, as part of the communication interface 220. Thus, the primary device 202 may serve as a mesh router in a mesh router system (comprising the primary device 202 and the AP 212) to provide seamless wireless coverage to client devices in a space. In this example, user device 216, or any other WI-FI enabled device, can connect to either AP 212 (via communication link 218) or AP 222 of primary device 202 (via communication link 224) to obtain access to one or more networks (e.g., a WAN such as the Internet). In FIG. 2B, the primary device 202 may be configured to manage three or more concurrent network connections (e.g., in different frequency ranges) including, for example: (1) connection 214 to AP 212, (2) connection 224 to one or more client devices (such as user device 216), and (3) connections 210 to the satellite devices 208.

FIG. 3A illustrates an example of a methodology that can be utilized by the primary device 202 to communicate audio content to the satellite devices 208. In some instances, the primary device 202 can utilize a “Round Robin” scheduling approach to communicate the audio content to the satellite devices 208. For example, the primary device 202 can receive a stream of audio content samples (300a, 300b, . . . 300n) from the display device 206. The audio content samples 300 can be communicated from the display device 206 at any of a variety of rates including, for example, 44.1 kilohertz (kHz), 48 kHz, 96 kHz, 176.2 kHz, and 192 kHz. The audio content samples 300 may comprise uncompressed audio content (e.g., Pulse-Code Modulation (PCM) audio) and/or compressed audio content (e.g., DOLBY audio such as DOLBY AC-3 audio, DOLBY E-AC-3 audio, DOLBY AC-4 audio, and DOLBY ATMOS audio). The display device 206 outputs the audio content samples 300 while beginning the process of rendering the video content on a display. Given that the display device 206 may take tens of milliseconds to successfully render the video content, the audio content samples 300 may be output just before the corresponding video content is displayed (e.g., tens of milliseconds earlier). The primary device 202 may coordinate playback of the audio content samples 300 in lip-synchrony with the video content being displayed on the display device 206 such that there is no perceived audio delay (i.e., no lip-syncing issues are perceived) by the viewer. In this regard, it can be shown that in some cases, an offset of no more than 40 ms between the video content being rendered and the audio content being heard is imperceptible to the average viewer. The primary device 202 may achieve lip-synchrony by, for example, exploiting one or more of the following periods of time: (1) a gap between the display device 206 outputting the audio content samples 300 and display device 206 actually displaying the associated visual content; and/or (2) an allowable delay between the visual content being displayed and the associated audio content being played back without losing lip-synchrony (e.g., up to 40 milliseconds).

After receiving a particular audio content sample 300a, the primary device 202 can extract the channel samples 305a (i.e., front-left, front-right, etc.) from the audio content sample 300a and can communicate the channel samples 302a to the corresponding satellite devices 208. In the illustrated examples in FIG. 3A, the channel samples 302a are communicated sequentially. For example, during a first interval, the primary device 202 can communicate the front-left channel sample (FL1) associated with a first audio content sample 300a to a first satellite device assigned to render the front left channel. During a second interval, the primary device 202 can communicate the front-right channel sample (FR1) associated with the first audio content sample 300a to a second satellite device assigned to render the front right channel. During a third interval, the primary device 202 can communicate the subwoofer channel sample (SB1) associated with the first audio content sample 300a to a third satellite device assigned to render the subwoofer channel. During a fourth interval, the primary device 202 can communicate the rear-left channel sample (RL1) associated with the first audio content sample 300a to a fourth satellite device associated to render the rear-left channel. During a fifth interval, the primary device 202 can communicate the rear-right channel sample (RR1) associated with the first audio content sample 300a to a fifth satellite device assigned to render the rear-right channel. The same process can repeat with the arrival of subsequent audio content samples from the display device 206, such as audio content sample 300b through audio content sample 300n.

In some examples, a single device (e.g., the primary device and/or any one or more of the satellite devices) may be assigned to render multiple audio channels simultaneously. As a result, a single transmission to a single satellite in accordance with the “Round-Robin” approach shown in FIG. 3A may comprise channel samples associated with multiple channels. For instance, a satellite device may be assigned to render both a right-rear channel and a height channel. In such an instance, a transmission to that satellite device may comprise a right-rear channel sample and a height channel sample for the satellite device to render.

Further, the primary device may communicate channel samples to multiple satellite devices 208 simultaneously. Simultaneous communication of audio content from the primary device 202 to the satellite devices 208 may be accomplished in any of a variety of ways. For example, certain wireless communication standards (e.g., 802.11ax, WI-FI 6, and/or WI-FI 6E) include orthogonal frequency-division multiple access (OFDMA) support that enables a given wireless channel to be subdivided into multiple smaller sub-channels. Each of these sub-channels may be employed to communicate with different devices independently from each other. In examples where the primary device 202 (and at least two of the satellite devices 208) support such a wireless communication standard, the primary device 202 may simultaneously transmit audio samples to two or more satellite devices 208 that support OFDMA.

In some instances, the satellite devices 208 may comprise a mix of one or more devices that support OFDMA (e.g., one or more devices that support 802.11ax, WI-FI 6, and/or WI-FI 6E) and one or more devices that do not support OFDMA (e.g., one or more devices that support an older backwards-compatible standard such as 802.11n, 802.11ac, WI-FI 4, WI-FI 5, etc.). In such instances, the primary device 202 may combine transmission of channel samples to multiple OFDMA capable satellite devices into a fewer number of transmissions than there are OFDMA capable satellite devices (e.g., into one transmission) while individually transmitting the other channel samples to the set of devices that do not support OFDMA. For example, the satellite devices 208 may comprise four devices that support OFDMA and two devices that do not. In this example, the primary device 202 may make three transmissions for each audio content sample including: (1) a first transmission to all four of the OFDMA capable satellites; (2) a second transmission to the first non-OFDMA capable satellite; and (3) a third transmission to the second non-OFDMA capable satellite.

In other examples, other techniques separate and apart from OFDMA may be employed to facilitate simultaneous communication of channel samples to satellite devices 204. For instance, the primary device 202 may simultaneously communicate with multiple satellite devices 208 using multiple wireless channels. For example, the channel samples 302a for a first subset of the satellite devices 208 can be communicated via a first wireless channel and the channel samples 302a for a second subset of the satellite devices 208 can be communicated via a second wireless channel that is different from the first wireless channel (e.g., a different channel in the same band as the first wireless channel or a different channel in a different band than the first wireless channel). In another example, the primary device 202 can broadcast the channel samples 302 for some or all satellite devices 208 to some or all satellite devices 208, and the individual satellite devices 208 may extract their relevant channel samples 302 from the broadcast transmission.

FIG. 3B illustrates an example of a methodology that can be utilized by the primary device 202 to communicate audio content to the satellite devices 208 that leverages the simultaneous communication capabilities described above. As shown, multiple channel samples may be transmitted simultaneously to multiple different satellite devices 208. For example, during a first interval, the primary device 202 may simultaneously communicate: (1) the front-left channel sample (FL1) to a first satellite device; (2) the front-right channel sample (FR1) to a second satellite device; (3) the rear-left channel sample (RL1) channel sample to a third satellite device; and (4) the rear-right channel sample (RR1) channel sample to a fourth satellite device. During a second interval, the primary device may communicate the subwoofer channel sample (SB1) to a fifth satellite device. The same process can repeat with the arrival of subsequent audio content samples from the display device 206, such as audio content sample 300b through audio content sample 300n.

It should be appreciated that the order in which the particular channel samples 302 are transmitted and the way in which the particular channel samples 302 are grouped for simultaneous transmission may vary based on the particular implementation. For example, the rear-left channel sample (RL1) and/or the rear-right channel sample (RR1) may be transmitted before the front-left channel sample (FL1) and/or the front-right channel sample (FR1). Additionally (or alternatively), the rear-left channel sample (RL1) may be transmitted simultaneously with the front-left channel sample (FL1) and/or the front-right channel sample (FR1). Thus, the particular channel samples 305a may be ordered and/or grouped in any of a variety of ways.

### IV. Example Wireless Communication Interface Architectures

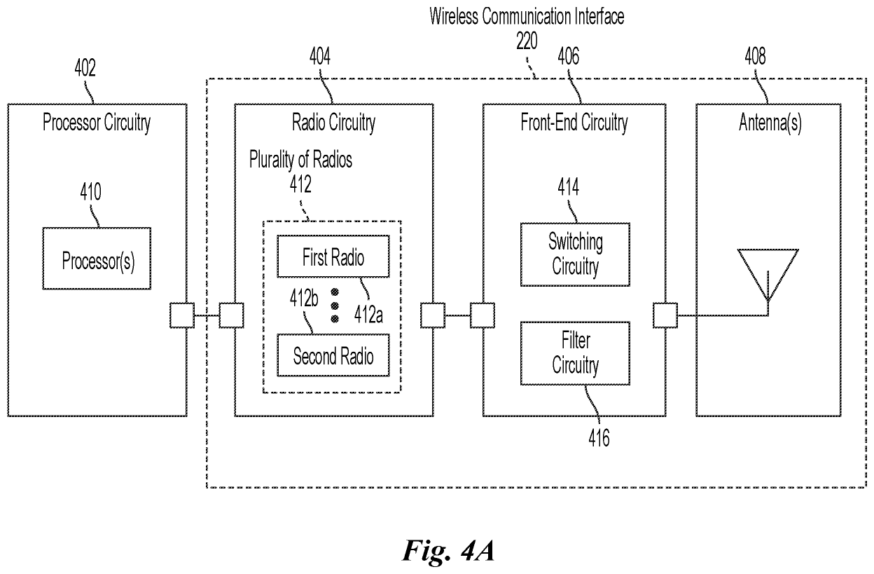

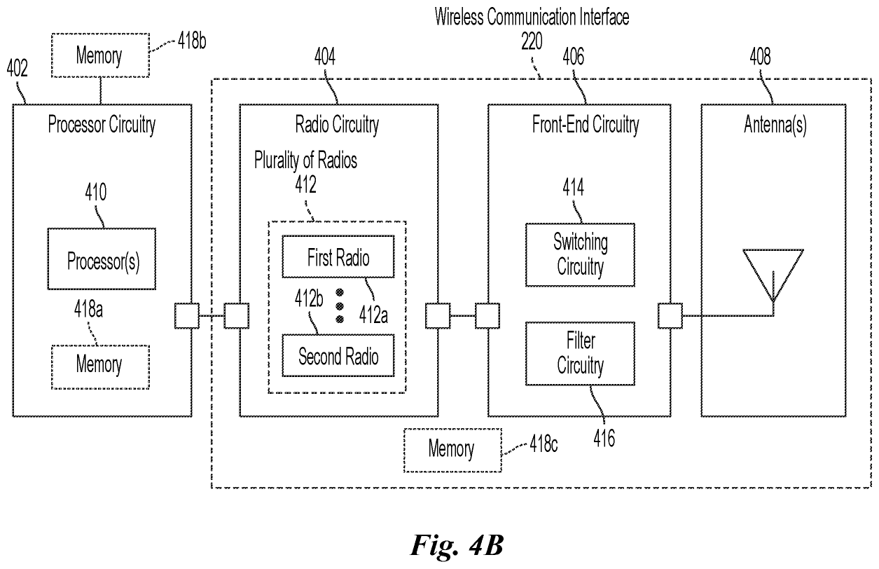

FIG. 4A illustrates an example of a logical diagram of the wireless communication interface 220 that may be integrated into any of the devices described herein, including the primary device 202. As shown, the wireless communication interface 220 may be communicatively coupled to processor circuitry 402 that may comprise one or more processors 410 (e.g., one or more processors 112a described above). The wireless communication interface 220 comprises radio circuitry 404 coupled to the processor circuitry 402 and to front-end circuitry 406, and one or more antennas 408 coupled to the front-end circuitry 406. The radio circuitry includes a plurality of radios 412 (shown as a first radio 412a and a second radio 412b). The front-end circuitry 406 includes switching circuitry 414 and filter circuitry 416.

The one or more processors 410 of the processor circuitry 402 execute instructions stored in memory (e.g., memory 112b) to facilitate performance of any of a variety of operations including, for instance, those operations described herein. Referring to FIG. 4B, the memory may be integrated into the processor circuitry 402 (e.g., memory 418a) or separate from the processor circuitry 402 (e.g., memory 418b). In some examples, the memory is integrated into the wireless communication interface 220 (e.g., memory 418c). In some examples, the memory may include any combination of one or more of the memory 418a, 418b, and/or 418c. The processor circuitry 402 may be implemented using one or more ICs that may be packaged separately, together in any combination, or left unpackaged. In some examples, the processor circuitry 402 may be implemented using a System-On-a-Chip (SoC) into which the processor(s) 410 may be integrated.

With continuing reference to FIGS. 4A and 4B, the radio circuitry 404 comprises the plurality of radios 412 to facilitate wireless communication. The plurality of radios 412 includes the first radio 412a and the second radio 412b. However, the plurality of radios 412 may include any number of radios (e.g., three radios, four radios, etc.) and is not limited to any particular number of radios. In some instances, the first radio 412a may be employed to facilitate communication over a backhaul connection (e.g., connection 214 in FIGS. 2A and 2B, or connection 224 in FIG. 2B) and the second radio 412b may be employed to facilitate communication with one or more satellite devices (e.g., connections 210 in FIGS. 2A and 2B). However, as described further below, in some examples, the role of the individual radios 412a, 412b, and the communication links associated therewith, may be dynamically altered/reconfigured to adapt to various conditions within the home theater environments 200a, 200b, or other environments in which the wireless communication interface 220 is used. The radio circuitry 404 may be implemented using one or more ICs that may be packaged separately, together in any combination, or left unpackaged. In some instances, the first radio 412a and the second radio 412b may be integrated into separate ICs. In other instances, the first radio 412a and the second radio 412b may be integrated into a single IC.

As shown in FIGS. 4A and 4B, in some examples, the front-end circuitry 406 is coupled between the radio circuitry 404 and the antennas 408, and comprises the switching circuitry 414 and the filter circuitry 416. The switching circuitry 414 may comprise one or more switches to control which of the antenna(s) 408 are coupled to which ports of the radio circuitry 404 based on received control signals (e.g., from the radio circuitry 404, the processor circuitry 402, or any component thereof). Examples of switches that may be incorporated into the switching circuitry 414 include: Single Pole Single Throw (SP1T) switches, Single Pole Double Throw (SP2T) switches, Single Pole Triple Throw (SP3T) switches, Double Pole Single Throw (DP1T) switches, Double Pole Double Throw (DP2T) switches, and/or Double Pole Triple Throw (DP3T) switches. The filter circuitry 416 may comprise one or more filters to filter signals going to (or being received from) the antenna(s) 408. Example filters that may be incorporated into the filter circuitry 416 include: bandpass filters, lowpass filters, highpass filters, all-pass filters, and diplexers. The front-end circuitry 406 may be implemented using one or more ICs that may be packaged separately, together in any combination, or left unpackaged.

The antenna(s) 408 may be configured to radiate and/or detect electromagnetic waves. The antenna(s) 408 may have any of a variety of constructions. For example, one or more of the antenna(s) 408 may be multi-band antennas (e.g., dual-band antennas, tri-band antennas, etc.) configured to operate on several bands (e.g., two or more of: the 2.4 GHz band, the 5 GHz band, and/or the 6 GHz band). Additionally (or alternatively), the antenna(s) 408 may comprise one or more single-band antennas configured to operate on a single band (e.g., the 2.4 GHz band (or any portion thereof), the 5 GHz band (or any portion thereof), the 6 GHz band (or any portion thereof), etc.).

In some examples, any one or any combination of the ICs described above with respect to processor circuitry 402, radio circuitry 404, and/or front-end circuitry 406 may be mounted to (or otherwise attached) to one or more substrates, such as a printed circuit board. In some instances, all of the ICs in the processor circuitry 402, radio circuitry 404, and/or front-end circuitry 406 may be mounted to a single circuit board. In other instances, the ICs in the processor circuitry 402, radio circuitry 404, and/or front-end circuitry 406 may be distributed across multiple circuit boards that may be communicatively coupled to each other (e.g., using one or more cables).

As described above, in certain examples, the primary device 202 is configured to establish both a fronthaul connection (e.g., including the communication links 210) for communication with the satellite device(s) 208, and a backhaul connection (e.g., including the communication link 214) for communication with the AP 212. Further, the fronthaul connection and the backhaul connection may be operational at the same time. Accordingly, in some examples, one of the radios 412 may be configured to establish the backhaul connection (and thus may be referred to as the “backhaul radio”) while another radio 412 is configured to establish the fronthaul connection (and may thus be referred to as the “fronthaul radio”). In some examples, the fronthaul connection and the backhaul connection may each be established in a particular frequency range/band using IEEE 802.11-based protocols. As described above, since the fronthaul and backhaul connections can operate simultaneously, the frequency ranges/bands selected for the fronthaul and backhaul connections may be non-overlapping, such that signal interference between the two connections can be avoided.

In some circumstances, the frequency band selected for the backhaul connection may be determined by a frequency band in which the AP 212 is set to operate. Thus, the communication interface 220 can be configured to establish the backhaul connection using the backhaul radio 412 (e.g., 412a) in a frequency band determined by the AP 212 (or in collaboration with the AP 212, as described further below) and then select a non-overlapping frequency band in which to establish the fronthaul connection using the fronthaul radio 412 (e.g., 412b). One approach to achieving this configuration is to dedicate one radio 412 (e.g., 412a) to the backhaul connection, while the other (e.g., 412b) is dedicated to the fronthaul connection. However, in some instances, it may not be known a priori, which frequency band will be selected for communication with the AP 212, and further, the frequency band in which the AP 212 is set to operate may change over time. Accordingly, dedicating individual radios 412 to be the fronthaul radio and the backhaul radio may involve each radio 412 to be capable of operating over at least some, and potentially all, possible frequency ranges that could be selected for either the backhaul connection or the fronthaul connection. In some instances, this may further involve the switching circuitry 414 and the filter circuitry 416 including duplicate components to provide dedicated radio frequency (RF) transceiver chains for each radio 412 in each frequency band. As described above, such a configuration may be expensive and space-inefficient.

Accordingly, certain examples provide an architecture that leverages the fact that the fronthaul and backhaul connections operate in different frequency bands or sub-bands to share front-end circuitry components, including filters and switches, among the fronthaul and backhaul radios. In addition, examples of the architectures disclosed herein further leverage the ability to flexibly select a frequency band for the fronthaul connection based on various factors, including the frequency band selected for the backhaul connection and/or operating characteristics of some or all satellite playback devices that communicate with the primary device over the fronthaul connection. Thus, as described further below, in some examples, this architecture allows for the provision of a dedicated fronthaul radio and backhaul radio that can accommodate various frequency band selections without the costly duplication of parts associated with some other configurations.

Further examples provide architectures for the wireless communication interface 220 in which individual radios 412 can be dedicated to one or more particular frequency bands, rather than being dedicated to the role of being the fronthaul radio or the backhaul radio. Accordingly, the filter circuitry 416 can include filters associated with each frequency band, rather than each radio, thereby avoiding at least some duplication of components. As described in more detail below, the switching circuitry 414 may be configured to selectively couple the individual radios 412 to components of the filter circuitry 416 based on the frequency band of operation of a respective radio. Further, the wireless communication interface 220 can be configured to dynamically assign or re-assign roles (e.g., fronthaul radio or backhaul radio) to individual radios 412 based on the frequency bands selected for operation of the backhaul connection and the fronthaul connection.

In certain examples, the wireless communication interface 220 comprises a radio IC (e.g., that includes or is part of the radio circuitry 404, as described above) including a first radio (e.g., radio 412a) configured to operate in a plurality of first frequency ranges and a second radio (e.g., radio 412b) configured to operate in a plurality of second frequency ranges. The plurality of first frequency ranges and the plurality of second frequency ranges may share at least one common frequency range. Further, at least one of the plurality of first frequency ranges may be a frequency range that is non-overlapping with any of the plurality of second frequency ranges. The wireless communication interface 220 further comprises the RF front-end circuitry 406, which may be coupled to the radio IC and configured to selectively couple each of the first and second radios to a respective antenna terminal to establish at least one first transceiver chain between the first radio and a first antenna terminal and at least one second transceiver chain between the second radio and a second antenna terminal. As described above, the RF front-end circuitry 406 includes the switching circuitry 414, which may include a plurality of switches, and the filter circuitry 416, which may include a plurality of filters. In some examples, the plurality of filters includes at least one first bandpass filter positioned in the first transceiver chain and at least one second bandpass filter positioned in the second transceiver chain. The plurality of first frequency ranges combined with the plurality of second frequency ranges may comprise: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

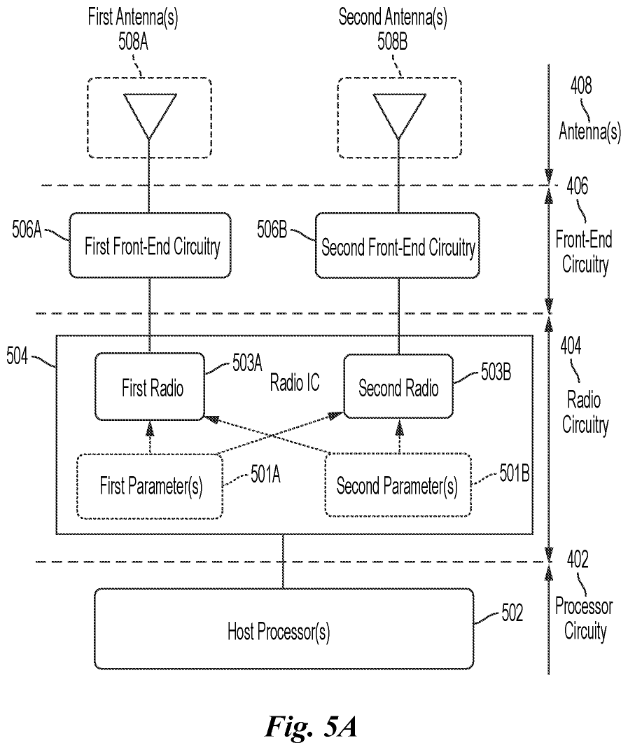

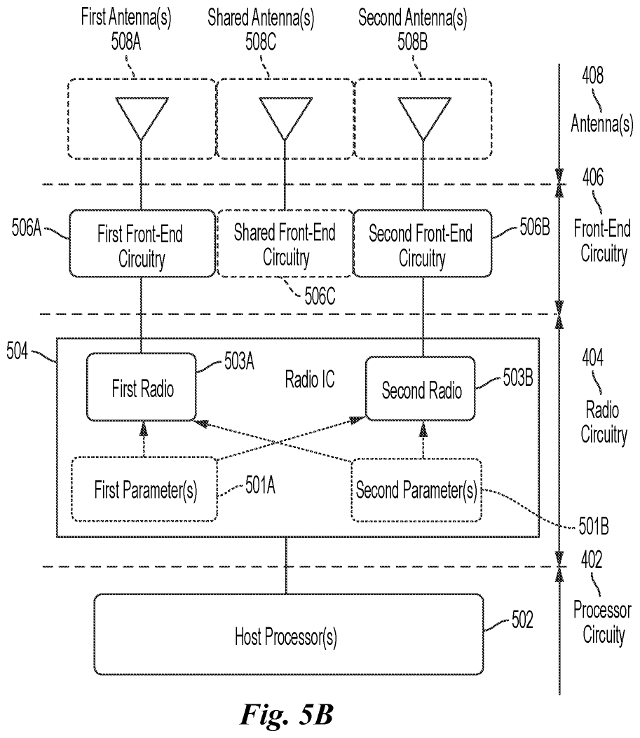

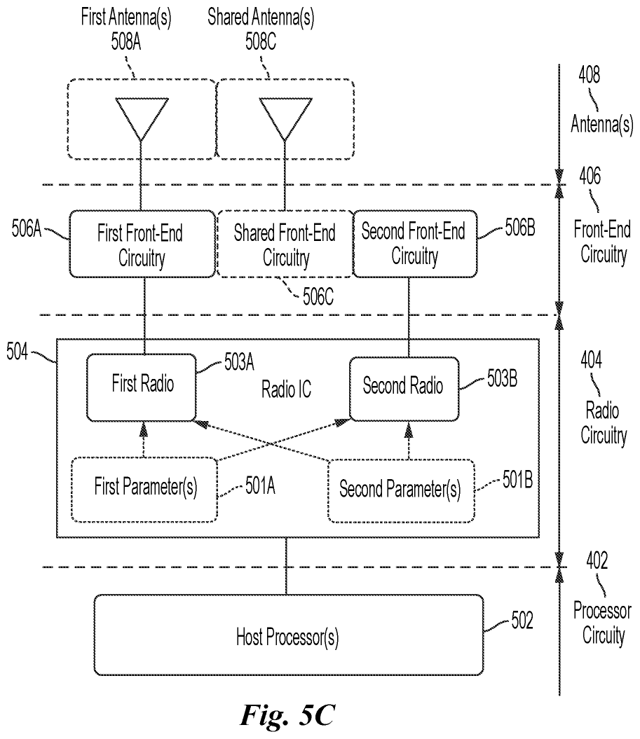

FIGS. 5A-C illustrate example architectures that may be used to implement embodiments of the wireless communication interface 220 having some or all of these characteristics and/or functionalities.

FIG. 5A depicts an example architecture of the wireless communication interface 220. In this example, the processor circuitry 402 comprises one or more host processor(s) 502, and the radio circuitry 404 comprises a radio IC 504 including a first radio 503A, a second radio 503B, first parameter(s) 501A, and second parameter(s) 501B. Also in this example, the front-end circuitry 406 comprises first front-end circuitry 506A and second front-end circuitry 506B, and the antenna(s) 408 comprise first antenna(s) 508A and second antenna(s) 508B.

The host processor(s) 502 may comprise one or more processors that function as the host for the radio IC 504. The host processor(s) 502 may be implemented as any of a variety of processors. In some instances, the host processor(s) 502 may include one or more application processors that may execute program instructions.

The radio IC 504 is coupled to the host processor(s) 502 and may comprise a plurality of radios shown as the first radio 503A and the second radio 503B. Each of the radios 503A and 503B may operate in accordance with a set of parameters shown as first parameter(s) 501A and second parameter(s) 501B. The first and second parameter(s) may comprise, for example, network parameters (e.g., IP address, MAC address, SSID, BSSID, etc.). The radio IC 504 may dynamically assign the first parameter(s) 501A and/or the second parameter(s) 501B to the first radio 503A and the second radio 503B. For instance, the radio IC 504 may switch assignment of the first parameter(s) 501A from being assigned to the first radio 503A to being assigned to the second radio 503B. Similarly, the radio IC 504 may switch assignment of the second parameters 501B from being assigned to the second radio 503B to being assigned to the first radio 503A. Such a switch of parameter assignment may be performed, for example, as part of a role switch of the first radio 503A and the second radio 503B, as described further below.

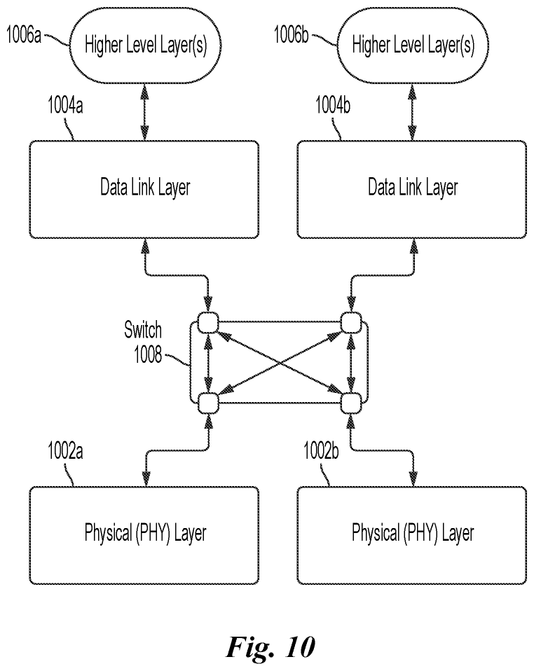

According to certain examples, to perform the radio role switching and switching of parameter assignments, separation is created between the physical (PHY) layer and the data link layer (which includes the MAC sub-layer) of the network protocol stack implemented in the radio IC 504, and a switch is positioned between these two layers, as illustrated in FIG. 10. The Open Systems Interconnection model (OSI model) is a conceptual model from the International Organization for Standardization (ISO) that describes a common framework for the communications, or network protocol, stack used by devices such as the radio IC 504. As shown in FIG. 10, a network protocol stack exists for each of the first and second radios 503A, 503B, and each network stack includes a physical layer 1002 (identified individually as 1002a, 1002b), a data link layer 1004 (identified individually as 1004a, 1004b), and one or more higher level layers 1006 (identified individually as 1006a, 1006b). A switch 1008 is positioned between the physical layers 1002 and the data link layers 1004, as shown. According to the OSI model, the physical layer 1002 is responsible for sending/receiving data bits over a physical communication medium (such a wire, conductive trace, cable, free space, etc.). The physical layer 1002 is agnostic or otherwise unaware of the information contained in the transferred bits, including information such as relevant addresses (e.g., MAC address, Internet Protocol (IP) address, etc.). Rather, the management of addresses is handled by higher layers of the network protocol stack including (but not limited to) the MAC layer within the data link layer 1004. Accordingly, in certain examples, the switching of address assignment between the first and second radios 503A, 503B, is performed as a switch of the connections between the physical layers 1002 and the data link layers 1004 (and higher level layers 1006).

The various layers of the network protocol stack for each of the first and second radios 503A, 503B, including the physical layers 1002, the data link layers 1004, and the higher level layers 1006, may be implemented in the radio IC 504 using software, hardware, or any combination thereof. Accordingly, the switch 1008 may be a programmatic switch implemented in software or may be a physical switch implemented in hardware, or some combination thereof.

In some examples, circuitry that implements the physical layers 1002 may be separate and distinct from the circuitry that implements the MAC sub-layer in each of the data link layers 1004. In some examples, the physical layer circuitry is implemented in one IC and the MAC sub-layer circuitry is implemented in a separate IC that communications with the physical layer circuitry IC over a media-independent interface. However, in other examples, the circuitry for both layers is integrated into a single system-on-a-chip (SoC). In either case, the switch 1008 can be provided to selectively connect the circuitry corresponding to either of the physical layers 1002a, 1002b to the circuitry corresponding to either of the data link layers 1004a, 1004b to thereby facilitate role switching between the first and second radios 503A, 503B. In some instances of such an implementation, the switch 1008 may be a physical switch implemented, at least primarily, in hardware.

In some examples, a radio SoC for each of the first and second radios 503A, 503B may include circuitry dedicated to the physical layer functionality and which is connected to one or more processors. In such examples, the circuitry that implements the physical layer functionality may include one or more input/output pins that connect to the front-end circuitry 506A, 506B. The radio IC 504 thus may comprise one or more processor(s) (not shown) that execute program instructions. Such program instructions may, in some instances, be stored on a memory (e.g., any one or more of the memory 418a, 418b, 418c shown in FIG. 4B)) in the radio IC 504. In some examples, the functionality of the data link layers 1004a, 1004b, (and of the higher level layers 1006) may be implemented, at least in part, in software. In some such instances, a common set of circuitry implements the functionality of the MAC sub-layers in both the data link layers 1004a, 1004b. Accordingly, the switch 1008 may be implemented as a software switch that switches the internal routing of data from a first internal interface to a second internal interface that swaps the data previously being routed to the circuitry associated with the physical layer 1002a of the first radio 503A to the circuitry associated with the physical layer 1002b of the second radio 503B (or vice versa).

Thus, the switch 1008 is configured to selectively operate between the physical layers 1002 and the data link layers 1004 in the radio IC 504 to swap parameters 501A, 501B assigned to the first and second radios 503A, 503B during a role switch, as described herein.

The front-end circuitry 506A may couple the first radio 503A to first antenna(s) 508A. Similarly, the second-end circuitry 506B may couple the second radio 503B to second antenna(s) 508B. In some instances, the front-end circuitry 506A and corresponding first antenna(s) 508A may be constructed differently from front-end circuitry 506B and corresponding second antenna(s) 508B to enable communication over a different set of frequency bands (and/or sub-bands). For example, the front-end circuitry 506A and corresponding first antenna(s) 508A may enable the first radio 503A to communicate over a first set of frequency bands and/or sub-bands (e.g., the 2.4 GHz band, a first portion of the 5 GHz band, and the 6 GHz band) while the front-end circuitry 506B and corresponding second antenna(s) 508B may enable the second radio 503B to communicate over a second set of frequency bands and/or sub-bands (e.g., a second portion of the 5 GHz band that is non-overlapping with the first portion, and the 6 GHz band) that is different from the first set of frequency bands and/or sub-bands.

In some examples, one or more components of the first front-end circuitry 506A may be shared with the second front-end circuitry 506B. Similarly, one or more antennas may be shared for communication via the first radio 503A and the second radio 503B. An example of such an implementation is shown in FIG. 5B that adds (relative to FIG. 5A) shared front-end circuitry 506C and shared antenna(s) 508C. In some implementations, all of the one or more antenna(s) employed for communication for a given radio may be entirely shared with another radio. FIG. 5C shows such an implementation where (relative to FIG. 5B) the second antenna(s) 508B are removed altogether and the second radio 503B exclusively employs shared antenna(s) 508C for wireless communication.

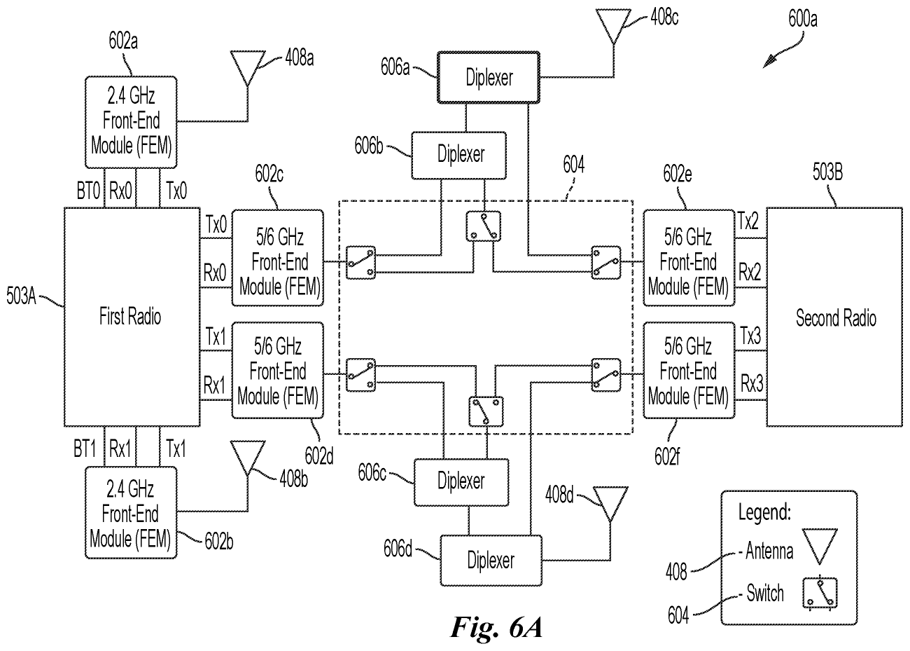

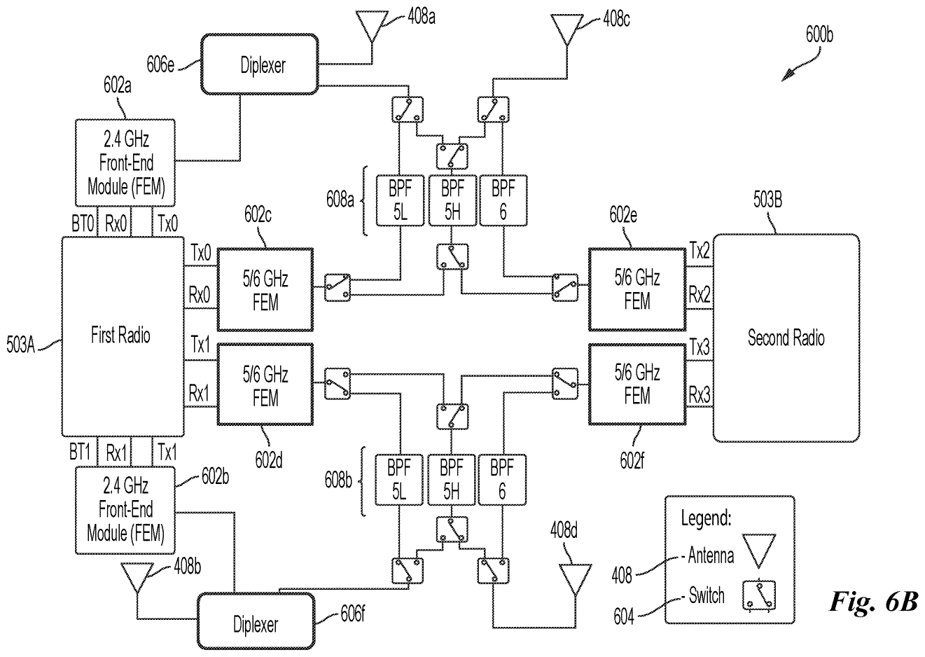

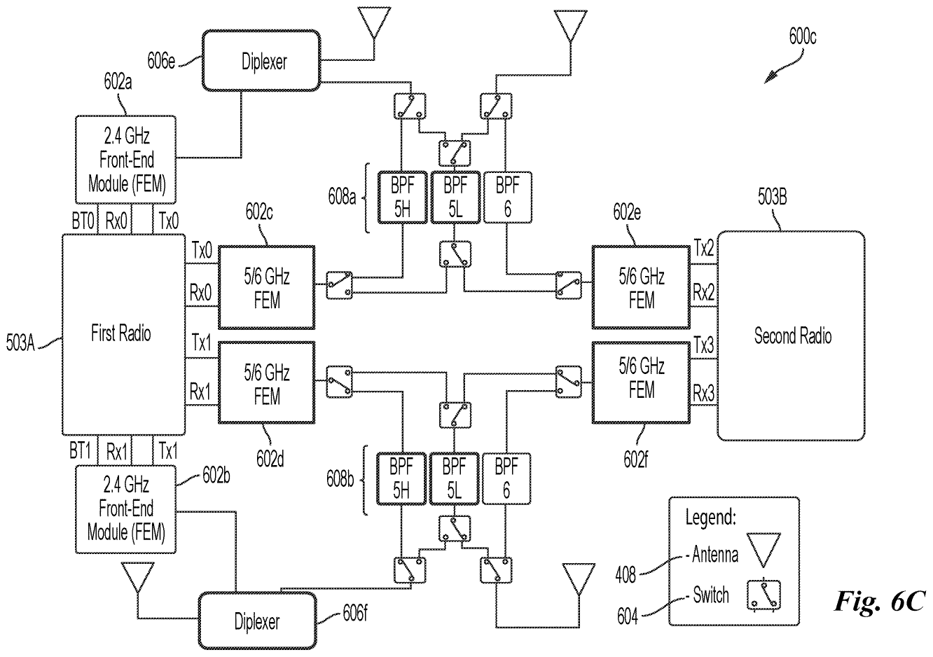

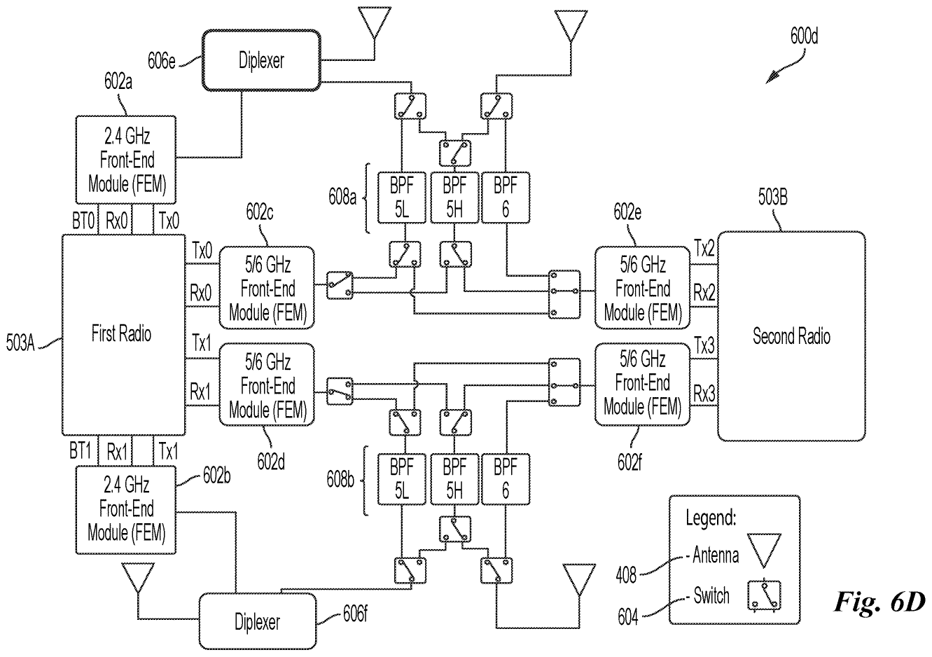

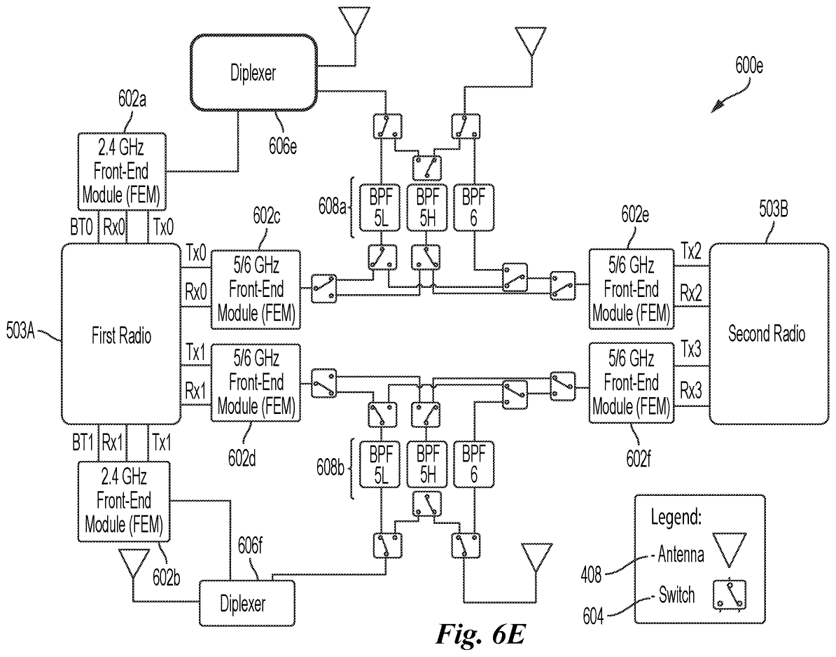

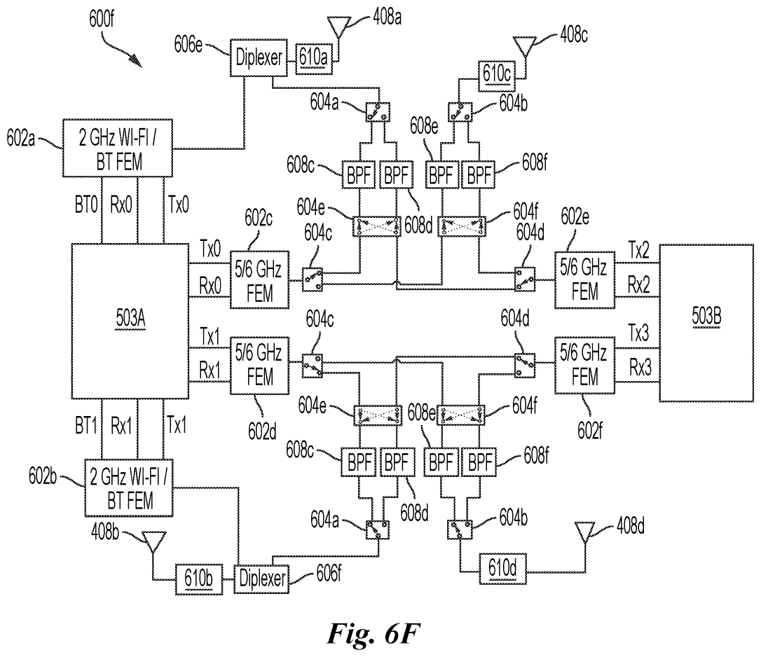

FIGS. 6A-6F depict various examples of circuitry 600 (identified individually as circuitry 600a-f in FIGS. 6A-F, respectively) that can be used to implement embodiments of the wireless communication 220 of FIGS. 5A-5C. In each illustrated example, the radio IC 504 (FIGS. 5A-5C) includes the first radio 503A and the second radio 503B. The front-end circuitry 406 (FIG. 4A) includes a plurality of front-end modules (FEMs) 602, individually identified in FIGS. 6A-F as FEMS 602a-f. In the illustrated examples, the wireless communication interface 220 is configured to operate in various combinations of the following frequency ranges: the 2.4 GHz band, a lower portion of the 5 GHz band, an upper portion of the 5 GHz band, and the 6 GHz band. Accordingly, the following examples and discussion refer primarily to these frequency ranges/bands; however, in other examples, the components can be configured for operation in other RF frequency ranges. Further, in examples of FIGS. 6A-6F, the circuitry 600 is configured to provide four WI-FI transceiver chains between the combination of the first and second radios 503A, 503B and the antennas 408, with each of the first and second radios 503A, 503B being configured to establish two of the four WI-FI transceiver chains. Thus, in FIGS. 6A-6F, the term Tx followed by a number (e.g., 0, 1, 2, or 3) refers to a WI-FI transmit terminal, the term Rx followed by a number (e.g., 0, 1, 2, or 3) refers to a WI-FI receive terminal. Further, the antennas 408 include four antennas identified individually as antennas 408a-d. However, in other examples, the circuitry 600 can be configured to provide more than four or fewer than four transceiver chains and may include more than four or fewer than four antennas 408. In addition, in the examples of FIGS. 6A-6F, the first radio 503A is also configured to establish two BLUETOOTH communication paths, and thus the term BT followed by a number (e.g., 0 or 1) refers to a BLUETOOTH transmit and/or receive terminal.

In the examples of FIGS. 6A-6F, the first radio 503A is coupled to the first and second FEMs 602a, 602b, which are in turn coupled to antennas 408a, 408b, respectively. In some examples, the first and second FEMs 602a, 602b are 2.4 GHz FEMs (e.g., they comprise components configured to pass RF signals in the 2.4 GHz band through to the respective antennas 408a, 408b, while optionally also attenuating RF signals outside of the 2.4 GHz band). Since some BLUETOOTH signals also operate in the 2.4 GHz band, the first radio 503A can be configured to establish the BLUETOOTH communication paths via the first and second FEMs 602a, 602b, as shown.

As also shown in FIGS. 6A-6F, the first radio 503A is coupled to third and fourth FEMs 602c, 602d, and the second radio 503B is coupled to fifth and sixth FEMs 602e, 602f. As described above, in certain examples, the frequency bands of interest for establishing the fronthaul and backhaul connections include the 2.4 GHz band, the 5 GHz band (which may be split into two non-overlapping portions, such as a 5 GHz High portion and a 5 GHz Low portion), and the 6 GHz band. Accordingly, in some examples, the FEMs 602c-f are 5 GHz and/or 6 GHz FEMs.

In some examples of the architectures illustrated in FIGS. 6A-6E, the first radio 503A is configured to operate in the 2.4 GHz band, the 5 GHz Low band, and/or the 5 GHz High band, and the second radio 503B is configured to operate in one or both of the 5 GHz Low band or the 5 GHz High band, and/or the 6 GHz band. Thus, in such examples, the FEMs 602c, 602d may be 5 GHz FEMs while the FEMs 602e, 602f may be 5 GHz and 6 GHz FEMs. In other examples, such as examples of the architecture illustrated in FIG. 6F, both the first and second radios 503A, 503B are configured to operate in any of the 5 GHz Low band, the 5 GHz High band, and the 6 GHz band, and the first radio 503A is additionally configured to operate in the 2.4 GHz band. Thus, in such examples, the FEMs 602c, 602d, 602e, and 602f may be 5 GHz and 6 GHz FEMs. Through configuration and operation of the front-end circuitry 406, including the switching circuitry 414 and/or the filtering circuitry 416, two different (non-overlapping) frequency bands, one for the first radio 503A and one for the second radio 503B, can be selected from among the pluralities of frequency bands supported by each radio 503A, 503B, and these frequency bands can be used to establish the fronthaul and backhaul connections in 802.11-based protocols, for example. FIGS. 6A-6F illustrate various examples of configuration of the switching circuitry 414 and/or filtering circuitry 416 that can be used to selectively and dynamically establish a WI-FI transceiver chain for each of the first and second radios 503A, 503B in selected, non-overlapping frequency bands.

Referring to FIG. 6A, in this example, the switching circuitry 414 includes a plurality of switches 604 and the front-end circuitry 406 further includes a plurality of diplexers 606 (individually identified as diplexers 606a-d). In this example, the FEMs 602c and 602e can be selectively coupled to the antenna 408c via a subset of the plurality of switches 604 (the upper three switches shown in FIG. 6A) and diplexers 606a and/or 606b. Similarly, the FEMs 602d and 602f can be selectively coupled to the antenna 408d via another subset of the plurality of switches 604 (the lower three switches shown in FIG. 6A) and diplexers 606c and/or 606d. By selectively activating the plurality of switches 604, a first WI-FI transceiver chain can be established between the first radio 503A and one of the antennas 408c or 408d, to provide for a wireless communication link to be established in either the 5 GHz Low band or the 5 GHz High band, and a second WI-FI transceiver chain can be established between the second radio 503B and the other of the antennas 408c or 408d, to provide for a wireless communication link to be established in either the 5 GHz Low band or the 6 GHz band. The arrangement of the active WI-FI transceiver chains and the selection of frequency bands can be dynamically reconfigured through activation of the plurality of switches 604, thus providing a flexible arrangement that can accommodate changing environmental conditions, as described further below.

Referring to FIGS. 6B-6E, in these examples, the filtering circuitry 416 (FIG. 4A) includes two sets of bandpass filters 608a, 608b, each set including three bandpass filters. The term BPF 5L refers to a bandpass filter that passes a lower portion of the 5 GHz band (5 GHz Low), the term BPF 5H refers to a bandpass filter that passes a higher portion of the 5 GHz band (5 GHz High), and BPF 6 refers to a bandpass filter that passes the 6 GHz band. In each of the examples shown in FIGS. 6B-6E, the switching circuitry 414 (FIG. 4A) includes a plurality of switches 604. In these examples, the front-end circuitry 406 (FIG. 4A) further includes diplexers 606e and 606f. In some examples, these diplexers 606e, 606f are 2.4 GHz/5 GHz diplexers, to allow the 2.4 GHz and 5 GHz transceiver chains from the first radio 503A to share common antennas 408a, 408b.

In the examples of FIGS. 6B-6E, the sets of bandpass filters 608a, 608b, in combination with the plurality of switches 604, selectively establish WI-FI transceiver chains between the first and second radios 503A, 503B and the antennas 408. Individual bandpass filters are provided in each transceiver chain, as shown.

In the example of FIG. 6B, the second radio 503B is configured to operate in the 5 GHz High and 6 GHz High bands. In the example of FIG. 6C, the second radio 503B is configured to operate in the 5 GHz Low and 6 GHz High bands. Thus, FIGS. 6B and 6C shown the same arrangement of the front-end circuitry 406; however, in FIG. 6C the positions of the 5L and 5H bandpass filters (in both filter sets 608a, 608b) are reversed due to the different operating bands of the second radio 503B.

FIG. 6D illustrates an architecture in which the switching circuitry 414 includes single-pole triple-throw switches. FIG. 6E illustrates an alternative architecture in which the switching circuitry 414 includes cascaded single-pole double-throw switches instead of the single-pole triple-throw switches.

FIG. 6F illustrates another example of an architecture in which the first and second radios 503A and 503B are both capable of operating in the 5 GHz low, 5 GHZ, and 6 GHz bands. In addition, the first radio 503A is capable of operating in the 2.4 GHz band, and therefore may be used to establish one or more BLUETOOTH transceiver chains as well as one or more WI-FI transceiver chains in the 2.4 GHz band. In the illustrated example, the circuitry 600f includes two 2 GHz WI-FI/BLUETOOTH FEMs 602a, 602b capable of establishing WI-FI and BLUETOOTH transceiver chains in the 2.4 GHz band. Further, the circuitry 600f includes the four 5/6 GHz FEMs 606c-f to establish various WI-FI transceiver chains in these bands. In the example illustrated in FIG. 6F, the circuitry 600f includes antenna connectors 610 (identified individually as antenna connectors 610a-d) that provide coupling between the various components (e.g., diplexers 606e, 606f and switches 604) to the antennas 408. It will be appreciated that these antenna connectors 610 may also be included in the circuitry 600a-e of FIGS. 6A-6E.

Still referring to FIG. 6F, in this example, the filtering circuitry 416 (FIG. 4A) includes two sets of bandpass filters 608, each set including four bandpass filters 608c-f. In some examples, the bandpass filters 608c and 608e are 5H bandpass filters (e.g., they pass at least a portion of the 5 GHz high band and attenuate signals outside of the passband), the bandpass filters 608d are 5L bandpass filters (e.g., they pass at least a portion of the 5 GHz low band and attenuate signals outside of the passband), and the bandpass filters 608f are 6 GHz bandpass filters. Further, in the example of FIG. 6F, the switching circuitry 414 (FIG. 4A) includes a plurality of switches 604, including two sets of four single-pole, double-throw switches 604a-d and two pairs of double-pole, double-throw switches 604e-f. Through operation of the switching circuitry 414, the first and second radios 503A, 503B can be coupled to the antennas 408 via appropriate ones of the bandpass filters 608c-f to establish at least two independent WI-FI transceiver chains in non-overlapping frequency bands, one of which can be used for the backhaul connection and the other for the fronthaul connection. The frequency bands for the fronthaul and backhaul connections can be dynamically selected by changing the configuration of the switching circuitry 414 (e.g., connections of the switches 604a-f), thus allowing the circuitry 600f to flexibly accommodate a variety of different conditions that may require or prefer different frequency band selections for the backhaul and/or fronthaul connections.

In all of the examples of FIGS. 6A-6F, activation of the switches 604, optionally under control of the processer circuitry 402 and/or the radio circuitry 404 (FIG. 4A), can configure the front-end circuitry 406 to establish different selected transceiver chains in various combinations of non-overlapping frequency bands between the first and second radios 503A, 503B and the antennas 408. It will be appreciated that the switching circuitry 414 can be controlled, for example, via digital control signals, to establish independent/non-overlapping transceiver chains between each of the first and second radios 503A, 503B and respective individual ones of the antennas 408. Table 1 below shows the frequency bands/sub-bands supported for each of the first radio 503A and the second radio 503B in the examples of each of FIGS. 6A-6F.

TABLE 1
Supported Frequency Bands/Sub-Bands for Radios in FIGS. 6A-6F

| | First Radio 503A | Second Radio 503B |
|---|---|---|
| | Frequency Band/ | Frequency Band/ |
| FIG. | Sub-Bands | Sub-Bands |
| 6A | 2.4 GHz, 5 GHz Low, 5 GHz High | 5 GHz Low, 6 GHz |
| 6B | 2.4 GHz, 5 GHz Low, 5 GHz High | 5 GHz High, 6 GHz |
| 6C | 2.4 GHz, 5 GHz Low, 5 GHz High | 5 GHz Low, 6 GHz |
| 6D | 2.4 GHz, 5 GHz Low, 5 GHz High | 5 GHz Low, 5 GHz |
| | | High, 6 GHz |
| 6E | 2.4 GHz, 5 GHz Low, 5 GHz High | 5 GHz Low, 5 GHz |
| | | High, 6 GHz |
| 6F | 2.4 GHz, 5 GHz Low, 5 GHz High, | 5 GHz Low, 5 GHz |
| | 6 GHz | High, 6 GHz |

In the examples of FIGS. 6A-E, and as described further below, the first and second radios 503A, 503B can be dynamically switched between operating the fronthaul connection and operating the backhaul connection by switching the roles of the radios. In the example of FIG. 6F, because each of the first and second radios 503A, 503B can support all three of the 5 GHz high, 5 GHz low, and 6 GHz frequency bands, the first radio 503A can be assigned to the backhaul connection (since, in some examples, the 2.4 GHz band may be used for the backhaul connection, whereas this band may not commonly be used for the fronthaul connection) and the second radio 503B can be assigned to the fronthaul connection. The configuration of the switches 604a-f and the bandpass filters 608c-f allows the circuitry 600f to support multiple fronthaul and backhaul configurations without performing role switches of the radios 503A, 503B. While radio role switching, and the associated circuitry configurations of FIGS. 6A-6E, may provide various benefits in some scenarios, as discussed herein, the ability to avoid role switching (while still supporting as many frequency band selections as achieved using role switching) by using embodiments of the circuitry 600f of FIG. 6F can also be advantageous.

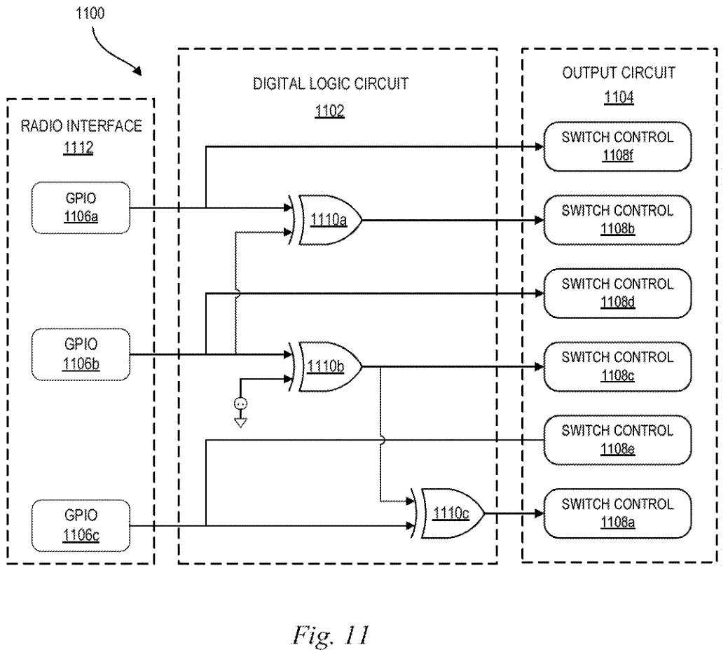

According to certain examples, a programmable digital logic circuit can be used to control operation of the switches 604a-f in the circuitry 600f to establish transceiver chains between the first and second radios 503A, 503B and selected ones of the antennas 408 that correspond to the fronthaul and backhaul connections. Referring to FIG. 11, there is illustrated an example of circuitry 1100 that can be used to control the switches 604a-f to establish the WI-FI transceiver chains in the circuitry 600f of FIG. 6. In this example, the circuitry 1100 includes a digital logic circuit 1102 and an output circuit 1104. The digital logic circuit 1102 is coupled to general purpose input/output (GPIO) terminals that form part of a radio interface 1112 of the radio IC 504. Although not shown in FIG. 11, the radio interface 1112 is coupled to the first and/or second radios 503A, 503B. In some examples, the radio IC 504 may include three available GPIO terminals 1106a-c that are also coupled to the radios 503A/B. However, as discussed above, in some examples of the circuitry 600f, the connections between the radios 503A, 503B and the antennas 408 to establish the fronthaul and backhaul transceiver chains may involve the use of six switches 604a-f. Accordingly, the digital logic circuit 1102 can be used to translate output signals from the three GPIO terminals 1106a-c to six switch control outputs 1108a-f, one for each switch 604a-f. In one example, the switch control output 1108a controls the switch(es) 604a, the switch control output 1108b controls the switch(es) 604b, the switch control output 1108c controls the switch(es) 604c, the switch control output 1108d controls the switch(es) 604d, the switch control output 1108e controls the switch(es) 604e, and the switch control output 1108f controls the switch(es) 604f. In the illustrated example, the digital logic circuit includes three exclusive-OR gates, 1110a-c coupled between the GPIO terminals 1106a-c and the output circuit 1104, as shown in FIG. 11. However, it will be appreciated that various other circuit configurations may be implemented. The digital logic circuit 1102 and the output circuit 1104 may be part of the radio IC 504, the radio circuitry 404, and/or the front-end circuitry 406.

As described herein, in some instances, the frequency band for the backhaul connection (which may be established using the first radio 503A in the example of FIG. 6F) is determined by one or factors/entities external to the wireless communication interface 220 and/or the processor circuitry 402. For example, the access point 212 may specify the frequency band for the backhaul connection 214. Accordingly, once the frequency band for the backhaul connection has been established, the frequency band for the fronthaul connection may be selected from the remaining supported non-overlapping frequency bands. As described further below, in some examples, selection of the frequency band for the fronthaul connection may be based on various factors, including, for example, capabilities of the satellite playback devices that are to be connected to the fronthaul connection (e.g., whether some or all satellite playback devices support a 6 GHz wireless network), and channel conditions/performance parameters (e.g., available bandwidth, congestion in wireless channels, etc.). In other examples, the primary device 202 may be capable of coordinating with or directing the access point 212 (or 222) to select the frequency band for the backhaul connection. In such cases, the frequency band for either the fronthaul connection or the backhaul connection can be selected first, and the frequency band for the other connection then selected from the remaining available non-overlapping bands (or sub-bands). In either scenario, once the frequency bands (or sub-bands) for the fronthaul and backhaul connections have been determined, the radio IC 504 can be configured to provide, via the radio interface 1112, appropriate signals to control operation of the switches 604a-f to establish the corresponding WI-FI transceiver chains, as described above.

To illustrate, consider the following example. In this example, the first radio 503A establishes the backhaul connection in the 5 GHz High sub-band and the second radio 503B establishes the fronthaul connection in the 6 GHz band. Accordingly, the switch control signal 1108c controls the switch 604c to connect the FEM 602c to the switch 604e. The switch control signal 1108e controls the switch 604e to establish a signal path to the 5 GHz High bandpass filter 608c. The switch control signal 1108a controls the switch 608a to connect the 5 GHz High bandpass filter 608c to the diplexer 606e, which in turn establishes a signal path via the antenna connector 610a to the antenna 408a. Thus, a wireless transceiver chain is established between the first radio 503A and the antenna 408a to provide for the backhaul connection. To establish a transceiver chain for the fronthaul connection, the switch control signal 1108d controls the switch 604d to connect the FEM 602e to the switch 604f. The switch control signal 1108f controls the switch 604f to establish a signal path to the 6 GHz bandpass filter 608f. The switch control signal 1108b controls the switch 608b to connect the 6 GHz bandpass filter 608f to the antenna 408c via the antenna connector 610c.

Table 2 below provides an example of frequency bands that can be selected for the backhaul and fronthaul connections using the circuitry 600f of FIG. 6F and the circuitry 1100 of FIG. 11.

TABLE 2
Supported Frequency Band/Sub-Band Pairs for Radios in FIG. 6F

| | |
|---|---|
| Backhaul Connection | Fronthaul Connection |
| Frequency Band/sub-band | Frequency band/sub-band |

| | | |
|---|---|---|
| 2.4 | GHz | 5 GHz Low |
| 2.4 | GHz | 5 GHz High |
| 2.4 | GHz | 6 GHz |

| | |
|---|---|
| 5 GHz Low | 5 GHZ High |
| 5 GHz Low | 6 GHz |
| 5 GHz High | 5 GHz Low |
| 5 GHz High | 6 GHz |

| | | |
|---|---|---|
| 6 | GHz | 5 GHz Low |
| 6 | GHz | 5 GHz High |

It will be appreciated that the examples discussed above and shown in FIGS. 6A-6F, and in FIGS. 5A-5C represent some architectures that can be used to implement the wireless communication interface 220 and achieve the functionality described herein; however, these examples represent only a select few of the full range of possible implementations.

### V. Example Methods

As described above with reference to FIG. 2A, in various instances, the primary device 202 establishes, using the wireless communication interface 220, the communication link 214 to the AP 212 to allow the primary device to connect to one or more external devices (such as the user device 216 or external computing devices hosting one or more cloud-based streaming services, for example). Thus, the primary device 202 can connect to a first wireless network (e.g., established by the AP 212) through the backhaul connection that it can establish using one of the radios 412. In some instances, the frequency band used for the backhaul connection is determined by the AP 212, since the AP 212 may establish the first wireless network without coordination with the primary device 202. In other examples, the primary device 202 may coordinate with the AP 212 to select the frequency band for the backhaul connection, as described further below. Once the primary device 202 has established the backhaul connection 214 to the AP 212, it may be desirable that the connection is maintained, to maintain association of the primary device 202 as a station (STA) with the AP 212, even as the primary device 202 forms and/or breaks other connections with other devices (such as the communication link(s) 210 with the satellite device(s) 208, for example). Accordingly, once the backhaul connection 214 is established in a particular frequency band, the primary device 202 can be configured to select a different, non-overlapping frequency band in which to establish a wireless network corresponding to the fronthaul connection (e.g., the communication link(s) 210).

In some examples, the primary device 202 may establish the fronthaul connection based on detecting an instruction to form or update a bonded group with one or more satellite devices 208. In some instances, the bonded group corresponds to a home theater group in which the satellite devices 208 (and optionally the primary device 202) render audio content in synchrony with each other and preferably in lip-synchrony with video content rendered by the display device 206, as described above. In other examples, the bonded group may be configured to synchronously render audio content received by the primary device 202 via the AP 212 (e.g., from a cloud-based music streaming service or from the user device 216). In either scenario, the primary device 202 establishes the fronthaul connection to allow transmission of audio content to the satellite devices 208. Various factors may influence selection of the frequency band and channel(s) for the fronthaul connection, as described further below.

In some embodiments, a method of operation for a playback device, such as the primary device 202, includes establishing, using a first radio (e.g., the first radio 503A), a connection to at least one external device (e.g., to or via the AP 212), establishing a wireless network using a second radio (e.g., the second radio 503B), and after detecting that one or more satellite playback devices 208 have connected to the wireless network, (i) receiving first audio content, and (ii) communicating one or more audio channels of the first audio content to the one or more other playback devices over the wireless network using the second radio. In some examples, after both the backhaul and fronthaul connections have been established, and potentially during an active playback session in which the bonded group is rendering audio content, the primary device may detect an event that affects one or both of the fronthaul and/or backhaul connections. However, as described above, it may be undesirable to disrupt the backhaul connection between the primary device 202 and the AP 212. Further, it may be undesirable to disrupt the fronthaul connection since doing so may cause interruption of the active playback session. Accordingly, as described further below, based on the event, the method of operation may include switching a role of the first radio with a role of the second radio such that the connection to the at least one external device is transitioned from the first radio to the second radio and the wireless network is transitioned from the second radio to the first radio. In this manner, both the fronthaul and backhaul connections can be maintained while the frequency channels/bands associated with one or both are altered by changing the role of the associated radio.

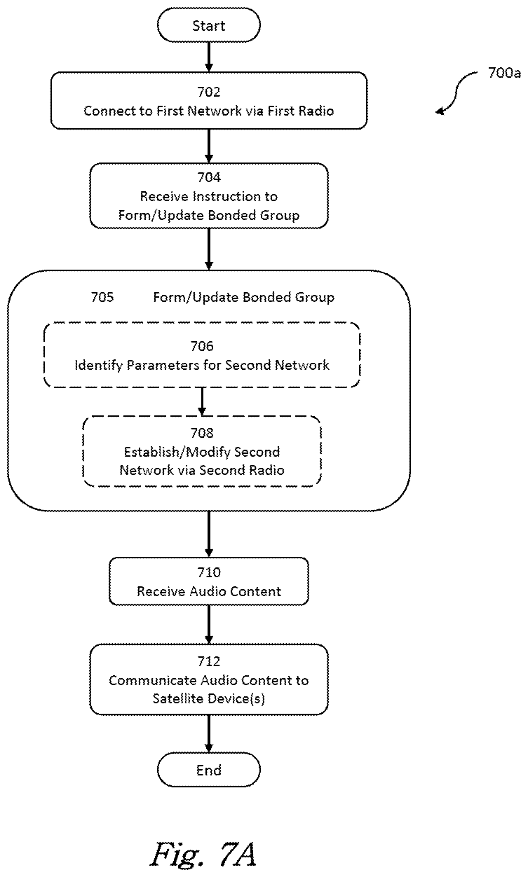

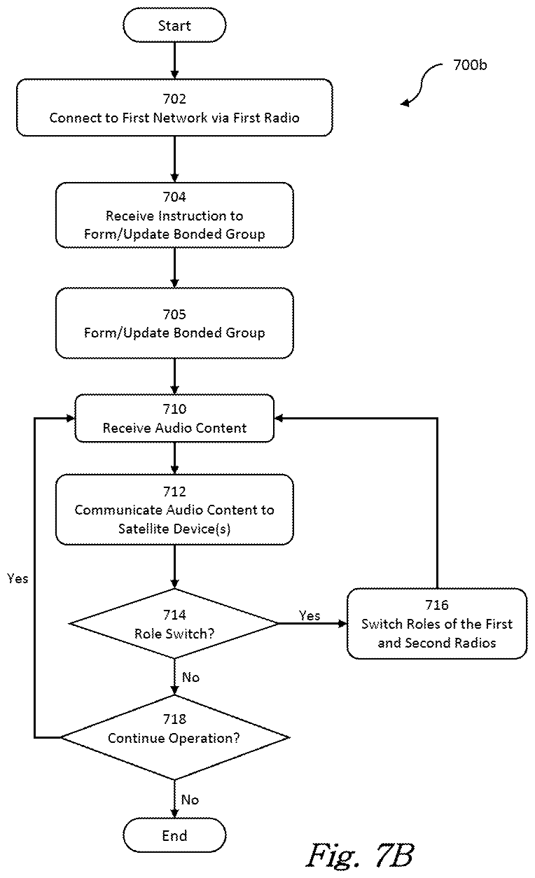

FIGS. 7A and 7B illustrate examples of methods of operation for a playback device, such as the primary device 202 or any other device described herein, during setup of and/or an update to a bonded group using the wireless communication interface architectures described herein. The operations may, in some instances, be distributed between multiple components of the primary device 202. For instance, as described above, the primary device may comprise host processor(s) (e.g., host processor(s) 502) and a radio IC (e.g., radio IC 504) and the operations of the primary device 202 described herein may be distributed across the host processor(s) and the radio IC. Such distribution of operations may be implemented in any of a variety of ways.

As shown, process 700a comprises an operation 702 of connecting to a first network using a first radio, an operation 704 of receiving an instruction to form/update a bonded group, an operation 705 of forming/updating the bonded group, an operation 710 of receiving audio content, and an operation 712 of communicating the audio content to satellite device(s). The operation 705 of forming/updating the bonded group may comprise an operation 706 of identifying parameters for a second network and an operation 708 of establishing/modifying the second network using the second radio. Referring to FIG. 7B, in certain examples, process 700b includes the operations of process 700a and, in addition, includes an operation 714 of determining whether a role switch is needed, an operation 716 of switching the role of the first and second radios, and an operation 718 of determining whether to continue operation.

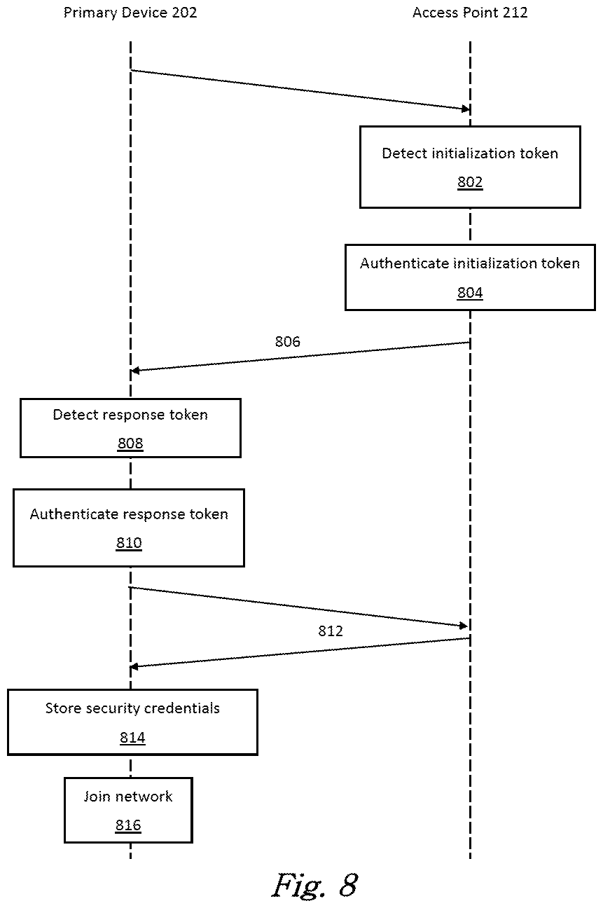

Referring to FIG. 7A, at operation 702, the primary device 202 may connect to a first network using a first radio. For example, the primary device may establish a backhaul connection to the AP 212 (e.g., connection 214 in FIG. 2A). The primary device 202 may, for example, establish the connection to the first network using security credentials received from the AP 212 during initial setup of the primary device 202. For example, FIG. 8 illustrates a method of establishing the backhaul connection 214 between the primary device 202 and the AP 212.

Referring to FIG. 8, operation 802 includes detecting, by the AP 212, a message communicating an initialization token from the primary device 202. The initialization token may include, for example, a certificate signed by a private key assigned to the primary device during manufacture. At operation 804, the AP 212 authenticates the initialization token to establish the primary device 202 as being a trusted primary device. The operation 804 may be performed locally, using a public key corresponding to the private key, or may involve exchanging messages with a remote identity provider. At operation 806, the AP 212 communicates a response token to the (trusted) primary device 202. The response token may include, for example, a certificate signed by a private key assigned to the AP 212 during manufacture. At operation 808, the primary device 202 detects a message communicating the response token from the AP 212. At operation 810, the primary device 202 authenticates the response token to establish the AP 212 as being a trusted device. The operation 810 may be performed locally, using a public key corresponding to the private key. At operation 812, the primary device 202 requests and receives security credentials for accessing the wireless network from the AP 212. At operation 814, the primary device 202 stores the security credentials. At operation 816, the primary device 202 joins the wireless network using the security credentials, thereby establishing the backhaul connection between the primary device 202 and the AP 212. After completion of the initialization process illustrated in FIG. 8, the primary device 202 can reconnect to the wireless network as needed using the stored security credentials. It will be appreciated that the method of FIG. 8 may be implemented by any playback device (not limited only to the primary device 202) to allow the playback device to autonomously join the wireless network provided by the AP 212.

In some examples, the processes described in operation 702 may be distributed across the host processor(s) 502 and the radio IC 504. For instance, the host processor(s) 502 may provide the radio IC 504 a list of SSIDs with matching credentials (e.g., to establish a backhaul connection to the AP 212). The radio IC 504 may then, using the provided SSIDs and credentials, establish and maintain a connection to a first network with any SSID that matches a provided SSID (using the associated credentials). For example, the radio IC 504 may establish the backhaul connection 214 to the AP 212 (e.g., without any further input from the host processor(s) 502) using one of the wireless radios 503A, 503B, as described above.

The radio IC 504 may select the radio from the plurality of radios 412 to establish the backhaul connection (e.g., serving a role as the backhaul radio) based on the frequency band (or sub-band) that the AP 212 is currently operating on. For instance, as described above with reference to FIGS. 6A-6F, in some examples, the first radio 503A is (through the front-end circuitry 406 and antennas 408) capable of communicating over the 2.4 GHz band in addition to one or more of a lower portion of the 5 GHz band (e.g., 5 GHz Low), an upper portion of the 5 GHz band (e.g., 5 GH High), and/or the 6 GHz band. Further, the second radio 503B (through the front-end circuitry 406 and antennas 408) may be capable of communicating over the one or both of the 5 GHz Low and/or 5 GH High bands and the 6 GHz band. In such an instance, the radio IC 504 may select the first radio 503A to serve as the backhaul radio in scenarios where the AP 212 is operating on a wireless channel in the 2.4 GHz band. In scenarios where the AP 212 is operating on a wireless channel in either the 5 GHz Low or 5 GHz High bands, the radio IC 504 may select either the first radio 503A or the second radio 503B to serve as the backhaul radio depending on the configuration of the wireless communication interface and the frequency band to be selected for the fronthaul connection, as described further below.

As discussed above, in some instances, the primary device 202 may have no control over the frequency band in which the AP 212 operates. In other examples, however, the primary device 202 may be able to influence selection of the frequency band of operation for the AP 212. In some such implementations, the radio IC 504 of the primary device 202 may prohibit certain frequency bands (or sub-bands) from being used to connect to the first network (e.g., to establish the backhaul connection 214). For instance, the radio IC 504 may reserve a specific frequency band (or sub-band), such as the 6 GHz band, for use to establish the second wireless network corresponding to the fronthaul connection, as described further below.

Referring again to FIG. 7A, at operation 704, the primary device 202 may receive an instruction to form/update a bonded group. For example, the primary device 202 may receive an instruction (e.g., from the user device 216) to form a bonded group with one or more satellite devices 208. Additionally (or alternatively), the primary device 202 may receive an instruction (e.g., from the user device 216) to modify an existing group (e.g., add a new satellite device, remove a satellite device, etc.).

In operation 705, the primary device 202 may form/update the bonded group based on the instruction received in operation 704. For example, the primary device 202 may establish a second network (corresponding to the fronthaul connection) for the one or more satellite devices 208 to connect to (e.g., to receive audio content) and/or assign particular roles for the satellites 208 to perform in the bonded group (e.g., assign a subset of audio channels from multi-channel audio content to render). The primary device 202 may form/update the bonded group in any of a variety of ways. For instance, the primary device 202 may perform one or more of operations 706 and 708 in forming/updating the bonded group.

At operation 706, the primary device may identify one or more parameters or characteristics for the second network/fronthaul connection. For instance, the primary device 202 may identify one or more of the following parameters for the second network: an operating band (e.g., 2.4 GHz band, 5 GHz band, 6 GHz band, etc.), a wireless channel (e.g., channels 1-11 in the 2.4 GHz band), a wireless channel width (e.g., 10 MHz, 20 MHz, 40 MHz, 80 MHz, 160 MHz, etc.), a signal modulation scheme (e.g., Binary Phase Shift Keying (BPSK), Quadrature Phase Shift Keying (QPSK), Quadrature Amplitude Modulation (QAM), etc.), one or more supported communication protocols (802.11g, 802.11n, 802.11ac, 802.11ac+, 802.11ax, etc.), guard intervals, coding rate (e.g., 1/2, 2/3, 3/4, 5/6), coding scheme (e.g., High Throughput Modulation and Coding Scheme (HT-MCS), Very High Throughput Modulation and Coding Scheme (VHT-MCS), etc.), security protocol (e.g., WEP, WPA, WPA2, WPA3, etc.), and/or transmit power level(s) (e.g., maximum transmit power level).

The primary device 202 may identify the one or more parameters for the second network based on any of a variety of information. In some examples, the primary device 202 identifies at least one of the one or more parameters for the second network based on one or more parameters for the first network. For example, the primary device 202 may identify a band (or sub-band) that is occupied for communication over the first network and set an operating band for the second wireless network to be one of the remaining (e.g., currently unused) bands (or sub-bands). Table 3 shows an example of band (and/or sub-band) options based on the band employed for communication over the first network.

TABLE 3
Example Band Options for Second Wireless Network

| First Network | Second Network Band/ |
|---|---|
| Band/Sub-Band | Sub-Band Options |
| 2.4 GHz | 5 GHz or 6 GHz |
| 5 GHz Low | 5 GHz High or 6 GHz |
| 5 GHz High | 5 GHz Low or 6 GHz |
| 6 GHz | 5 GHz Low or 5 GHz High |

In some examples, information separate and apart from the one or more parameters associated with the first network may be taken into account when identifying the one or more parameters for the second network. For instance, the primary device 202 may measure (or detect measurements of) the network congestion on a plurality of wireless channels (e.g., in the same frequency band or across multiple frequency bands) and consider the network congestion measurements in selecting the channel and/or frequency band/sub-band to be employed for the second wireless network (e.g., select a wireless channel with lower congestion). Additionally (or alternatively), the primary device 202 may prioritize some wireless channels and/or frequency bands/sub-bands over other wireless channels and/or frequency bands/sub-bands. For instance, wireless channels that require dynamic frequency selection (DFS) may be deprioritized relative to those channels that do not require DFS (e.g., a wireless channel that does not require DFS may be selected over a channel with less congestion that does require DFS). Additional examples of information that may be taken into account when identifying the one or more parameters for the second network include, but are not limited to: (1) capabilities of the satellite devices in the bonded group such as audio rendering capabilities (e.g., a number of audio channels that can be simultaneously rendered) and/or wireless communication capabilities (e.g., supported communication protocols, supported frequency spectrums, etc.); (2) regulatory requirements (e.g., allowed wireless channels, transmit power levels, etc.) of the geographic region in which the device is operating (e.g., Europe, USA, China, etc.); (3) existence (or absence) of a wired connection between the primary device 202 and any one or more satellite devices 208; and (4) state information associated with one or more playback devices (e.g., wireless channel(s) used by another primary device to communicate to another set of one or more satellite devices in another part of the environment 101). Accordingly, any of a variety of information sources and information derived therefrom may be employed to identify the one or more parameters for the second network.

At operation 708, the primary device 202 establishes/modifies the second network based on the one or more parameters identified at operation 706.

In some examples, the operations described in operation 705 may be distributed across the host processor(s) 502 and the radio IC 504. For instance, in operation 706 of identifying parameters for the second network, the host processor(s) 502 may provide information about the devices that are to participate in the bonded group to the radio IC 504 (e.g., supported communication protocols, supported frequency spectrums, etc.). The radio IC 504 may, in turn, employ such information (alone or in combination with other information) to determine the parameters for the second network. After the parameters for the second network have been determined, the radio IC 504 may, in operation 708, establish/modify a second network via the second radio.

At operation 710, the primary device 202 receives audio content for a playback session. The audio content may be, for example, multi-channel audio content associated with visual content rendered by the display device 206, as described above. The audio content may be received via a physical interface and/or via a wireless interface.

At operation 712, the primary device 202 communicates (e.g., transmits) audio content to the satellite devices 208 over the second network (the fronthaul connection). As described above in some examples, the audio content may be multi-channel content. Accordingly, in such examples, the primary device 202 may communicate the appropriate subsets of the multi-channel content (e.g., appropriate audio channels) to each of the respective satellite devices 208, optionally using one of the methodologies described above with reference to FIGS. 3A and 3B. The satellite devices 208 may, in turn, render the received audio content in synchrony with each other and in lip-synchrony with visual content displayed by the display device 206.

Referring now to FIG. 7B, as described above, in some circumstances an event may occur, and be detected by the primary device 202, that affects one or both of the backhaul connection and/or the fronthaul connection. In some instances, responding to this event may involve switching the roles of the first and second radios 503A, 503B, as described above.

Accordingly, at operation 714, the primary device 202 may determine whether a role switch is needed and/or achievable. A role switch may include, for example, switching a role of the first radio (e.g., to serve as the backhaul radio to establish/maintain a connection to the first network) with a role of the second radio (e.g., to serve as the fronthaul radio to establish/maintain a second network). A role switch may be needed in any of a variety of situations. For instance, a wireless channel that the first network is operating on may change to a wireless channel that is not accessible by the first radio. In such an instance, a role switch may be needed to allow the radio IC 504 to maintain the backhaul connection to the first network. In another example, one or more network characteristics or channel conditions of the second wireless network (e.g., channel congestion, signal strength, etc.) may change such that it becomes desirable to change the wireless channel on which the fronthaul connection is operating. If a desired new wireless channel for the fronthaul connection is not supported by the second radio, or selection of the desired new wireless channel would require changing of the backhaul connection to a (non-interfering) wireless channel not supported by the first radio, a solution may be to perform a role switch between the first and second radios. Various other scenarios that indicate that a role switch is desirable may be envisioned as well.

In some examples, the primary device 202 may determine that a role switch is needed, but not desirable and/or achievable. For example, as described further below, if the role switch cannot be performed within a specified time interval, the primary device 202 may determine that the role switch cannot be performed. In another example, if a wireless channel is not available to accommodate the role switch, the primary device may determine that the role switch cannot be performed. For example, based on the settings of the AP 212 (e.g., which frequency bands or sub-bands can/cannot be used), the capabilities of the satellite devices 208 (e.g., whether some or all satellites support 6 GHz connectivity), channel conditions in the various frequency bands, and/or other factors, a role switch may not be viable even if the primary device 202 determines at operation 714 that a role switch is needed.

If, at operation 714, the primary device 202 determines that a role switch is needed/desired and achievable, the primary device 202 may proceed to operation 716 and switch roles of the first and second radios 503A, 503B. The role switch may be performed at least in part by, for example, switching one or more parameters 501A or 501B assigned to the first radio 503A (e.g., MAC address, IP address, SSID, BSSID, etc.) with one or more parameters 501A or 501B assigned to the second radio 503B. In some instances, the radio IC 504 may switch/transition the roles of the first and second radios 503A, 503B, as needed, to move the connection to the first network from the first radio 503A to the second radio 503B and move the second network from the second radio 503B to the first radio 503A (or vice versa). The radio IC 504 may control the state of one or more switches in the switching circuitry 414 to effectuate these role transitions.

After the role transition is complete, the primary device 202 may return to operation 710 of receiving audio content for playback.

If, at operation 714, the primary device 202 determines that a role switch is not needed or cannot be performed, the primary device may proceed to operation 718 to determine whether to continue operation. For example, if at operation 714 the primary device 202 determines that a role switch is needed, but not viable, operation may not continue. In some examples, if the primary device 202 detects that the user has changed/destroyed the bonded group involving the satellite devices 208, the primary device 202 may discontinue the process 700b at operation 718 and optionally perform other operations. For example, if the primary device 202 detects that all of the satellite devices 208 have been removed from the bonded group, the process 700 may end at operation 718 and the fronthaul radio may be turned off. If operation is to continue, the primary device 202 may return to operation 710 and receive audio content for playback. Otherwise, the process 700b shown in FIG. 7B may end.

As described above, when establishing the second wireless network at operation 705, when determining whether a role switch is needed at operation 714, and/or when implementing the role switch at operation 716, the primary device 202, and more particularly, the radio IC 504, may evaluate/consider a variety of different information that may be supplied by or acquired from various different sources. Further, as discussed above, particular operations, or acts/processes involved in performing any of the above-described operations, may be distributed between the radio IC 504 and the host processor(s) 502.

For example, at operation 705, the radio IC 504 may select a frequency band and/or sub-band, and a wireless channel, for the second network to operate in based on any of a variety of information internally derived by the radio IC 504 or provided by the host processor(s) 502. In some instances, the host processor(s) 502 may provide information indicative of the wireless communication capabilities of the playback devices expected to connect to the second network (e.g., an indication of whether the playback devices support 6 GHz or not). If the playback devices are expected to support 6 GHz, the radio IC 504 may prioritize wireless channels in the 6 GHz band over wireless channels in all other bands e.g., 2.4 GHZ, 5 GHZ, etc.). If the playback devices are not expected to support 6 GHz, the radio IC 504 may prioritize wireless channels in the 5 GHz band over wireless channels in all other bands (e.g., 2.4 GHZ, 6 GHZ, etc.). As described above, the radio IC 504 may avoid selecting a wireless channel for the second network that is in the same band (or sub-bands if a given band is divided into sub-bands) as the first network.

Further, the radio IC 504 may maintain metrics on the quality of one or more channels in one or more frequency bands. The radio IC 504 may use this information at operations 706 and/or 708, for example, as a basis for selecting a channel with less congestion for the second network. Similarly, the radio IC 504 may use this information at operation 714 to determine whether or not a role switch is needed/desired. For example, if a current operating channel of the second wireless network has become congested or is otherwise exhibiting poor performance metrics, this may suggest a role switch if another, better-performing channel is not available within a frequency channel, band or sub-band that is supported by both the radio currently serving as the fronthaul radio and the satellite devices 208. For example, threshold analysis could be performed on the metrics to determine whether a role switch might be indicated.

In various examples, there may be advantages associated with the radio IC 504 having the capability to execute one or more of the operations and/or acts or processes associated therewith without requiring intervention or assistance from the host processor(s) 502. For example, acting alone, the radio IC 504 may be able to determine the need for and execute a role switch more quickly (and therefore with less potential for disruption) than with involvement of the host processor(s) 502. Further, significant resources of the host processor(s) 502 may be involved in other operations (e.g., rendering audio) of the primary device 202 (or other playback devices) not directly related to establishment of the wireless connections. Therefore, by enabling the radio IC 504 to perform actions related to establishing and maintaining the wireless connections without involvement of the host processor(s) 502, the host processor resources can be dedicated to the other operations, which may streamline or otherwise improve overall performance of the primary device 202 (or other playback devices).

In some instances, one or more of operations 714 and/or 716 are entirely performed by and/or under the direction of the radio IC 504. For example, the radio IC 504 may determine whether a role switch is needed in operation 714 and (if a role switch is needed) transition the roles of the first and second radios in operation 716. Such operations may be performed by the radio IC 504 without any intervention or prompting by, for example, host processor(s) 502.

In addition, in some examples, the radio IC may reconfigure the second wireless network (e.g., at operations 708 and/or 718) with or without implementing a role switch at operation 716. For example, the radio IC 504 may (without intervention from the host processor(s) 502) determine that the current channel used by the second wireless network is too congested (e.g., to support low latency audio). In such instances, the radio IC 504 may (without intervention from the host processor(s) 502) move the second network to a new channel in the same band or a different band or sub-band. In some examples, such a transition may be performed and completed within a time interval of 10 milliseconds or less to avoid interruption of communications over the wireless network.

As described above, in some instances, the frequency band or sub-band used for the backhaul connection 214 is selected without any control/influence by the primary device 202. For example, the AP 212 may independently select the frequency band/sub-band for the first wireless network, and therefore the primary device 202 may establish the backhaul connection within that frequency band/sub-band and select a different frequency band/sub-band for the second wireless network as described above. However, in other examples, the primary device 202 may be able to communicate with the AP 212 to collaboratively select an operating frequency band or sub-band for the first wireless network. For example, as described above, the radio IC 504 may identify a certain frequency band or sub-band as being most preferable for establishment of the second wireless network, and therefore request or instruct that the AP 212 not use this frequency band or sub-band for the first wireless network (and the backhaul connection 214). For instance, the radio IC 504 may reserve a specific frequency band (or sub-band), such as the 6 GHz band, for use to establish the second wireless network corresponding to the fronthaul connection. The choice of preferred frequency band or sub-band may be based on channel condition metrics and/or capabilities of the satellite devices 208, as described above.

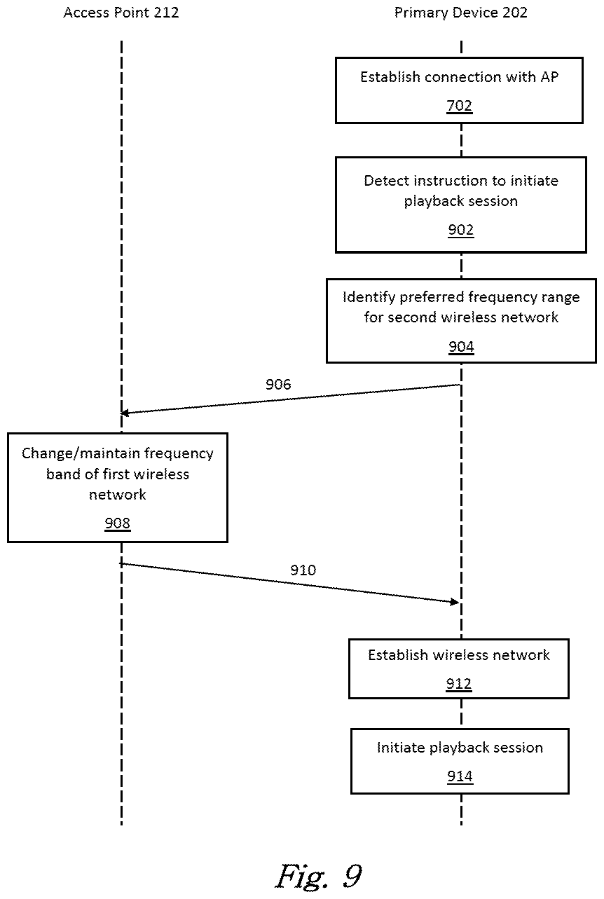

Thus, referring again to FIGS. 7A and 7B and to FIG. 9, in some embodiments, a playback device, such as the primary device 202, may be configured to implement a process for establishing the fronthaul connection based on various factors, including whether or not the AP 212 can be instructed to change the frequency band or sub-band used for the first wireless network.

As discussed above, at operation 702, the primary device 202 connects to the first wireless network provided by the AP 212 by establishing the backhaul connection 214 in the current frequency band of operation of the first wireless network using a first radio (e.g., radio 503A).

At operation 902, the primary device 202 detects an instruction to initiate playback of audio content by at least one satellite playback device 208. In some examples, operation 902 includes or corresponds to operation 704 discussed above.

After detecting the instruction, at operation 904, the primary device (e.g., with the radio IC 504) may scan a plurality of frequency ranges (e.g., any or all of the 2.4 GHz, 5 GHZ (5 GHz High and/or 5 GHz Low), or 6 GHz bands discussed above) to identify a preferred frequency range from among the plurality of frequency ranges. The preferred frequency range may be the frequency range most preferable to use for establishment of a second wireless network, and the fronthaul connection, for communication of audio content to the satellite device(s) 208, as described above. The preferred frequency range may be identified based on various factors, as also described above.

At operation 906, if the preferred frequency range corresponds to or overlaps with the current frequency band of operation of the first wireless network, the primary device 202 may transmit a request to the AP 212 to change the wireless channel used for the first wireless network.

At operation 908, the AP 212 may either deny the request (and maintain the first wireless network in the same current frequency channel) or accept the request and change the operating frequency band or sub-band of the first wireless network. For example, the AP 212 may transition the first wireless network from a 5 GHz band to the 2.4 GHz band, or from the 6 GHz band to a 5 GHz band or the 2.4 GHz band.

At operation 910, the AP 212 may communicate a response to the primary device 202 indicating whether the request was accepted or denied.

At operation 912, based on the response from the AP 212, the primary device 202 establishes, using either the first or second radios 503A, 503B, a second wireless network within one of the frequency ranges. In some examples in which the wireless communication interface is implemented using the circuitry 600f of FIG. 6F, the primary device may establish the second wireless network using the second radio 503B regardless of whether the request is accepted or denied at operation 910. As described above, in the circuitry 600f, both the first and second radios 503A, 503B may be capable of operating in all of the 5 GHz Low, 5 GHz High, and 6 GHz bands, and therefore the second radio may accommodate, or “work around,” any frequency band used for the first wireless network. In some examples, if the request is denied, the primary device may establish the fronthaul connection using the second radio (e.g., radio 503B). In other examples in which the wireless communication interface is implemented using any of the circuitry 600a-e of FIGS. 6A-6E, if the request is granted, the primary device 202 may implement a role switch (operations 714 and 716), depending on the frequency ranges to be used for each of the first and second wireless networks and the capabilities of the first and second radios 503A, 503B, as discussed above. In such cases, the radio IC 504 of the primary device may transition the backhaul connection to the second radio (e.g., radio 503B) and establish the second wireless network using the first radio (e.g., radio 503A).

At operation 914, after detecting that the satellite playback device(s) 208 have connected to the second wireless network, the primary device 202 initiates the playback session. As discussed above with reference to FIG. 2A, operation 914 may include receiving audio content at the primary device 202 (via either connection 214 or connection 204, for example), and communicating one or more audio channels of the audio content to the satellite playback device(s) over the fronthaul connection. In some examples, operation 914 corresponds to operations 710 and 712 described above with reference to FIG. 7A.

In some examples, the primary device 202 (e.g., using the radio IC 504) may prevent a role switch from occurring if it is determined that the role switch would disrupt or otherwise negatively impact an ongoing playback session. For example, the radio IC 504 may be configured to allow a role switch only if the transition can be accomplished within a particular time interval (e.g., 10 milliseconds or less) that is sufficiently short so as not to cause a noticeable disruption in the playback session.

For example, as discussed above, various operations may involve scanning a plurality of wireless channels within one or more frequency bands or sub-bands (e.g., to detect an available and/or preferred wireless channel for establishment of the fronthaul connection, or to identify the first wireless network and establish the backhaul connection). Such scanning may be performed by the radio IC 504. In some instances, the radio IC 504 may need access to a band through which the second network is currently operating (e.g., to scan for and/or associate with the first network). In these instances, the radio IC 504 may move the second network to a new channel in a different band and/or sub-band. Such a transition may involve a role transition of a first and second radios, as described above. The transition may occur within an interval of 10 milliseconds or less to avoid interrupting communications over the second network. If the transition is to take longer than 10 milliseconds (e.g., due to design constraints or when the particular situation in which the radio IC is operating renders this objective impossible), the radio IC 504 may prevent the transition from occurring when the second network is in use to avoid interruption.

In other examples, the radio IC 504 can be configured to disfavor a role switch (e.g., use a less desirable wireless channel for the fronthaul connection because that wireless channel can be used without requiring a role switch) based on certain factors, such as there being an active playback session. Further, as described above, wireless channels that require dynamic frequency selection (DFS) may be disfavored over those channels that do not require DFS (e.g., a wireless channel that does not require DFS may be selected over a channel with less congestion that does require DFS). Thus, in some examples, in determining a preferred wireless channel for the fronthaul connection, the radio IC 504 can be configured to calculate a channel score associated with some or all available channels. In some examples, a penalty value can be applied to the channel score for wireless channels that would involve a role switch during an active playback session. In some examples, the host processor(s) 502 may indicate to the radio IC 504 whether audio is being played, and thus whether or not the penalty value should be applied. The radio IC 504 may select the wireless channel for establishment of the fronthaul connection based on the channel scores, including the penalty score when appropriate.

According to certain embodiments, during periods when audio is not being played (e.g., no active playback session involving the primary device 202), the radio IC 504 may (e.g., without intervention from the host processor(s) 502) perform one or more maintenance tasks. Such maintenance tasks may include, for example, scanning one or more channels (e.g., one or more DFS channels) as part of a Channel Availability Check (CAC) (e.g., required to be completed prior to communication over the channel). In some instances, such scanning of one or more channels may require movement of the playback devices to a different channel as they may, in some examples, need to be on a different channel that is in the one or more channels being scanned as part of the CAC. Additionally (or alternatively), the radio IC 504 may perform one or more operations to refresh channel metrics used for channel selection. In the event that the radio IC 504 receives an indication from the host processor(s) 502 that a playback session is to begin, the radio IC 504 may stop performing such maintenance tasks and return to normal operation within a specified time interval (e.g., within 10 milliseconds). For instance, if the radio IC 504 is scanning a channel as part of a CAC, the radio IC 504 may stop the CAC and select a wireless channel to employ for the fronthaul connection (e.g., by performing some or all of the operations discussed above with reference to FIGS. 7A-9) such that the primary device 202 can stream audio to the satellite device(s) 208.

Thus, aspects and embodiments provide flexible communication architectures and methods that can allow a playback device to adapt to various and changing conditions in the media playback system environment in which it is employed to provide a streamlined, consistent, and enjoyable user experience.

### VI. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for the implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular element, structure, or characteristic described in connection with the embodiment can be included in at least one example embodiment of the technology. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well-known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Additional Examples

Example 1 provides a playback device comprising at least one wireless communication interface comprising a first radio and a second radio, at least one processor, and at least one non-transitory computer-readable medium. The playback device further comprises program instructions stored on the at least one non-transitory computer-readable medium that are executable by the at least one processor such that the playback device is configured to: establish, using the first radio, a connection to at least one external device (e.g., a wireless access point (AP)); after receipt of an instruction (e.g., via the first radio) to form a bonded group that comprises the playback device and a satellite playback device, establish a wireless network using the second radio; after the satellite playback device has connected to the wireless network, (i) receive first audio content (e.g., via the second radio, an audio port such as an optical port and/or an High-Definition Multimedia Interface (HDMI) input, etc.), and (ii) communicate at least a portion of the first audio content to the satellite playback device over the wireless network using the second radio, switch a role of the first radio with a role of the second radio such that the connection to the at least one external device is transitioned from the first radio to the second radio and the wireless network is transitioned from the second radio to the first radio; after switching a role of the first radio with a role of the second radio, (i) receive second audio content (e.g., via the second radio, an audio port such as an optical port and/or an High-Definition Multimedia Interface (HDMI) input, etc.), and (ii) communicate at least a portion of the second audio content to the satellite playback device over the wireless network using the first radio.

Example 2 includes the playback device of Example 1, wherein the at least one processor comprises a first processor and a second processor and wherein a first portion of the program instructions are executable by the first processor and a second portion of the program instructions are executable by the second processor.

Example 3 includes the playback device of Example 2, wherein the first processor is integrated into the at least one wireless communication interface and wherein the second processor is a host processor.

Example 4 include the playback device of one of Examples 2 or 3, wherein the at least one non-transitory computer-readable medium comprises a first memory integrated into the at least one wireless communication interface, and a second memory.

Example 5 includes the playback device of Example 4, wherein the first portion of the program instructions are stored in the first memory and the second portion of the instructions are stored in the second memory.

Example 6 includes the playback device of any one of Examples 1-5, wherein the first radio and the second radio are integrated into a single radio integrated circuit (IC).

Example 7 includes the playback device of any one of Examples 1-6, wherein the at least one wireless communication interface is configured to facilitate communication over a plurality of frequency ranges.

Example 8 includes the playback device of Example 7, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 9 includes the playback device of Example 8, wherein each of the plurality of frequency ranges comprises a plurality of wireless channels.

Example 10 includes the playback device of any one of Examples 7-9, wherein the at least one wireless communication interface is configured to facilitate wireless communication via the first radio on only a first subset of the plurality of frequency ranges and facilitate communication via the second radio on only a second subset of the plurality of frequency ranges, wherein the first subset is different from the second subset.

Example 11 includes the playback device of Example 10, wherein the first subset includes at least one frequency range in common with the second subset.

Example 12 includes the playback device of Example 10, wherein the first subset does not overlap with the second subset.

Example 13 provides a method of operation for a playback device, the method comprising: establishing, using the first radio, a connection to at least one external device (e.g., a wireless access point (AP)), receiving an instruction (e.g., via the first radio) to form a bonded group that comprises the playback device and a satellite playback device, after receiving the instruction, establishing a wireless network using the second radio, and after the satellite playback device has connected to the wireless network, (i) receiving first audio content (e.g., via the second radio, an audio port such as an optical port and/or an High-Definition Multimedia Interface (HDMI) input, etc.), and (ii) communicating at least a portion of the first audio content to the satellite playback device over the wireless network using the second radio. The method further comprises: switching a role of the first radio with a role of the second radio such that the connection to the at least one external device is transitioned from the first radio to the second radio and the wireless network is transitioned from the second radio to the first radio, and after switching a role of the first radio with a role of the second radio, (i) receiving second audio content (e.g., via the second radio, an audio port such as an optical port and/or an High-Definition Multimedia Interface (HDMI) input, etc.), and (ii) communicating at least a portion of the second audio content to the satellite playback device over the wireless network using the first radio.

Example 14 provides a playback device configured to implement the method of Example 13.

Example 15 provides a playback device comprising at least one processor and a wireless communication interface. The wireless communication interface comprises a plurality of antennas, and a radio integrated circuit (IC) including a first radio configured to operate in a plurality of first frequency ranges and a second radio configured to operate in a plurality of second frequency ranges, wherein the plurality of first frequency ranges and the plurality of second frequency ranges share at least one common frequency range, and wherein at least one of the plurality of second frequency ranges is a frequency range that is non-overlapping with any of the plurality of first frequency ranges. The wireless communication interface further comprises radio frequency (RF) front-end circuitry coupled to the radio IC and to the plurality of antennas, the RF front-end circuitry configured to selectively couple a respective one or more antennas of the plurality of antennas to each of the first and second radios to establish at least one first transceiver chain between the first radio and the respective one or more antennas and at least one second transceiver chain between the second radio and the respective one or more antennas. The playback device further comprises at least one non-transitory computer-readable storage medium coupled to the at least one processor and storing program instructions that are executable by the at least one processor to cause the playback device to receive from an external device, via the wireless communication interface, an audio stream representing audio content, and transmit to at least one other playback device, via the wireless communication interface, data representing at least one audio channel of the audio content.

Example 16 includes the playback device of Example 15, wherein the program instructions include program instructions that are executable by the at least one processor to control selection of a first operating frequency range for the first radio from among the plurality of first frequency ranges, and selection of a second operating frequency range for the second radio from among the plurality of second frequency ranges, wherein the first and second operating frequency ranges are non-overlapping.

Example 17 includes the playback device of Example 16, wherein the RF front-end circuitry comprises a network of switches configured to selectively couple the respective one or more of the plurality of antennas to each of the first and second radios.

Example 18 includes the playback device of Example 15, wherein the RF front-end circuitry further comprises a first filter set including one or more first filters coupled to the first radio and configured to pass the first operating frequency range and to suppress the second operating frequency range, and a second filter set including one or more second filters coupled to the second radio and configured to pass the second operating frequency range and to suppress the first operating frequency range.

Example 19 includes the playback device of Example 18, wherein the RF front-end circuitry further comprises at least one shared bandpass filter, and wherein the network of switches includes one or more switches configured to selectively couple one of the first radio or the second radio to the antenna module via the at least one shared bandpass filter.

Example 20 includes the playback device of any one of Examples 15-19, wherein the at least one processor includes a first processor and a second processor, wherein the first processor is integrated with the wireless communication interface and the second processor is a host processor, and wherein a first portion of the program instructions are executable by the first processor and a second portion of the program instructions are executable by the second processor.

Example 21 includes the playback device of Example 20, wherein the at least one non-transitory computer-readable storage medium comprises a first memory integrated into the wireless communication interface and a second memory, and wherein the first portion of the program instructions are stored in the first memory and the second portion of the program, instructions are stored in the second memory.

Example 22 includes the playback device of any one of Examples 15-21, wherein each of the plurality of first frequency ranges and the plurality of second frequency ranges comprises a respective plurality of wireless channels.

Example 23 includes the playback device of any one of Examples 15-22, wherein the plurality of first frequency ranges in combination with the plurality of second frequency ranges comprise: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, a 6 GHz band in 802.11-based protocols, and a 2.4 GHz band in Bluetooth protocols.

Example 24 includes the playback device of any one of Examples 15-23, wherein to receive the audio stream, the at least one tangible non-transitory computer-readable storage medium stores program instructions that are executable by the at least one processor to cause the playback device to establish, using one of the first or second radios, a wireless connection to the external device.

Example 25 includes the playback device of Example 24, wherein to transmit the data to the at least one other playback device, the at least one tangible non-transitory computer-readable storage medium stores program instructions that are executable by the at least one processor to cause the playback device to establish a wireless network using the other of the first or second radios, and after the at least one other playback device has connected to the wireless network, communicate the data to the at least one other playback device over the wireless network.

Example 26 includes the playback device of any one of Examples 15-25, wherein the plurality of antennas includes at least one BLUETOOTH antenna.

Example 27 includes the playback device of any one of Examples 15-26, further comprising one or more speakers, and one or more amplifiers coupled to the one or more speakers, wherein the program instructions include program instructions that are executable by the at least one processor to cause the playback device to render one or more audio channels of the audio content in synchrony with rendering of the at least one audio channel of the audio content by the at least one other playback device.

Example 28 provides a playback device comprising at least one processor, one or more speakers, one or more amplifiers coupled to the one or more speakers, an antenna module including a plurality of antennas, and a wireless communication interface coupled to the antenna module and configured to facilitate communication over a plurality of frequency ranges. The wireless communication interface comprises a radio integrated circuit (IC) including a first radio and a second radio, and radio frequency (RF) front-end circuitry coupled to the radio IC and to the antenna module, the RF front-end circuitry configured to selectively couple a respective one or more of the plurality of antennas to each of the first and second radios to establish at least one first transceiver chain between the first radio and the antenna module and at least one second transceiver chain between the second radio and the antenna module, wherein the wireless communication interface is configured to facilitate wireless communication via the first radio on only a first subset of the plurality of frequency ranges and facilitate communication via the second radio on only a second subset of the plurality of frequency ranges, wherein the first subset is different from the second subset.

Example 29 includes the playback device of Example 28, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and 6 GHz band in 802.11-based protocols.

Example 30 includes the playback device of Example 29, wherein the antenna module includes a BLUETOOTH antenna, wherein the RF front-end circuitry includes one or more switches and one or more filters configured to establish a third transceiver chain between the BLUETOOTH antenna and at least one of the first or second radios, and wherein the plurality of frequency ranges further comprises a 2.4 GHz band in BLUETOOTH protocols.

Example 31 includes the playback device of any one of Examples 28-30, wherein the RF front-end circuitry comprises a network of switches configured to selectively couple the respective one or more of the plurality of antennas to each of the first and second radios.

Example 32 includes the playback device of Example 31, wherein the RF front-end circuitry further comprises a plurality of filters including at least one first bandpass filter positioned in the first transceiver chain and at least one second bandpass filter positioned in the second transceiver chain.

Example 33 includes the playback device of Example 31, wherein the RF front-end circuitry comprises dedicated front-end circuitry associated with one of the first or second radios; and common front-end circuitry shared between the first and second radios, wherein the dedicated front-end circuitry and the common front-end circuitry each includes at least one RF filter.

Example 34 includes the playback device of any one of Examples 28-33, further comprising at least one non-transitory computer-readable medium storing program instructions that are executable by the at least one processor such that the playback device is configured to: establish, using the first radio, a connection to at least one external device, after receipt of an instruction to form a bonded group that comprises the playback device and a satellite playback device, establish a wireless network using the second radio, after the satellite playback device has connected to the wireless network, (i) receive first audio content, and (ii) communicate at least a portion of the first audio content to the satellite playback device over the wireless network using the second radio, switch a role of the first radio with a role of the second radio such that the connection to the at least one external device is transitioned from the first radio to the second radio and the wireless network is transitioned from the second radio to the first radio, and after switching the role of the first radio with the role of the second radio, (i) receive second audio content, and (ii) communicate at least a portion of the second audio content to the satellite playback device over the wireless network using the first radio.

Example 35 includes the playback device of any one of Examples 28-33, further comprising at least one non-transitory computer-readable medium storing program instructions that are executable by the at least one processor such that the playback device is configured to: receive from an external device, via the wireless communication interface, an audio stream representing audio content, and transmit to at least one other playback device, via the wireless communication interface, data representing at least one audio channel of the audio content.

Example 36 includes the playback device of Example 35, wherein the at least one non-transitory computer-readable medium further stores program instructions that are executable by the at least one processor such that the playback device is configured to render one or more audio channels of the audio content in synchrony with rendering of the at least one audio channel of the audio content by the at least one other playback device.

Example 37 provide a wireless communication interface for a playback device, the wireless communication interface comprising a radio integrated circuit (IC) including a first radio configured to operate in a plurality of first frequency ranges and a second radio configured to operate in a plurality of second frequency ranges, wherein the plurality of first frequency ranges and the plurality of second frequency ranges share at least one common frequency range, and wherein at least one of the plurality of second frequency ranges is a frequency range that is non-overlapping with any of the plurality of first frequency ranges, and radio frequency (RF) front-end circuitry coupled to the radio IC and configured to selectively couple each of the first and second radios to a respective antenna terminal to establish at least one first transceiver chain between the first radio and a first antenna terminal and at least one second transceiver chain between the second radio and a second antenna terminal, the RF front-end circuitry including a plurality of switches and a plurality of filters, wherein the plurality of first frequency ranges combined with the plurality of second frequency ranges comprise: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and 6 GHz band in 802.11-based protocols.

Example 38 includes the wireless communication interface of Example 37, wherein the RF front-end circuitry comprises dedicated front-end circuitry associated with one of the first or second radios, and common front-end circuitry shared between the first and second radios.

Example 39 includes the wireless communication interface of one of Examples 37 or 38, wherein plurality of filters includes at least one first bandpass filter positioned in the first transceiver chain and at least one second bandpass filter positioned in the second transceiver chain.

Example 40 provides a playback device comprising at least one processor and at least one wireless communication interface configured to facilitate communication over a plurality of frequency ranges, the at least one wireless communication interface comprising a first radio and a second radio. The playback device further comprises at least one non-transitory computer-readable medium storing program instructions that are executable by the at least one processor such that the playback device is configured to: establish, using the first radio, a connection to at least one external device, establish a wireless network using the second radio, after detecting that one or more other playback devices have connected to the wireless network, (i) receive first audio content, and (ii) communicate one or more audio channels of the first audio content to the one or more other playback devices over the wireless network using the second radio, detect an event, and based on the event, switch a role of the first radio with a role of the second radio such that the connection to the at least one external device is transitioned from the first radio to the second radio and the wireless network is transitioned from the second radio to the first radio.

Example 41 includes the playback device of Example 40, wherein the at least one non-transitory computer-readable medium further stores program instructions that are executable by the at least one processor such that the playback device is configured to: detect an instruction to form a bonded group with the one or more other playback devices, and after receipt of the instruction, establish the wireless network using the second radio.

Example 42 includes the playback device of Example 41, wherein at least one non-transitory computer-readable medium further stores program instructions that are executable by the at least one processor such that the playback device is configured to: after switching the role of the first radio with the role of the second radio, (i) receive second audio content, and (ii) communicate at least a portion of the second audio content to the one or more other playback devices over the wireless network using the first radio.

Example 43 includes the playback device of any one of Examples 40-42, wherein the event includes at least one of an instruction to change a source of the first audio content, an instruction to transition from playback of the first audio content to playback of second audio content, a change in one or channel conditions of the wireless network, a change in one or more channel conditions of the connection to the at least one external device, an instruction to form a bonded group with one or more satellite playback devices, or an instruction to add a satellite playback device to a bonded group including the playback device and at least one other satellite playback device.

Example 44 includes the playback device of any one of Examples 40-43, wherein the at least one processor comprises a first processor and a second processor and wherein a first portion of the program instructions are executable by the first processor and a second portion of the program instructions are executable by the second processor.

Example 45 includes the playback device of Example 44, wherein the first processor is integrated into the at least one wireless communication interface and wherein the second processor is a host processor.

Example 46 includes the playback device of any one of Examples 40-43, wherein the at least one non-transitory computer-readable medium comprises a first memory integrated into the at least one wireless communication interface and a second memory, and wherein the first portion of the program instructions are stored in the first memory and the second portion of the program instructions are stored in the second memory.

Example 47 includes the playback device of Example 46, wherein the second portion of the program instructions instruct the second processor to communicate one or more identifiers of one or more frequency ranges selected for the wireless network from the plurality of frequency ranges, and wherein the first portion of the program instructions instruct the first processor to establish the wireless network within the one or more frequency ranges.

Example 48 includes the playback device of any one of Examples 40-47, wherein to establish the wireless network, the at least one non-transitory computer-readable medium further stores program instructions that are executable by the at least one processor such that the playback device is configured to: scan at least some of the plurality of frequency ranges to select, from among the plurality of frequency ranges, a selected frequency range not occupied by the connection to the at least one external device, and establish the wireless network using the selected frequency range.

Example 49 includes the playback device of any one of Examples 40-48, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 50 includes the playback device of Example 49, wherein each of the plurality of frequency ranges comprises a plurality of wireless channels.

Example 51 includes the playback device of any one of Examples 40-50, wherein the at least one wireless communication interface is configured to facilitate wireless communication via the first radio on only a first subset of the plurality of frequency ranges and facilitate communication via the second radio on only a second subset of the plurality of frequency ranges, wherein the first subset is different from the second subset.

Example 52 includes the playback device of Example 51, wherein the first subset includes at least one frequency range in common with the second subset.

Example 53 includes the playback device of Example 51, wherein the first subset and the second subset share no common frequencies.

Example 54 includes the playback device of any one of Examples 40-52, wherein the at least one wireless communication interface includes a BLUETOOTH interface coupled to at least one of the first or second radios, and wherein the plurality of frequency ranges includes a 2.4 Gigahertz (GHz) band in BLUETOOTH protocols.

Example 55 includes the playback device of any one of Examples 40-54, wherein the first and second radios are integrated into a single radio integrated circuit (IC).

Example 56 provides a method of operation for a playback device, the method comprising: establishing, using a first radio, a connection to at least one external device, establishing a wireless network using a second radio, after detecting that one or more other playback devices have connected to the wireless network, (i) receiving first audio content, and (ii) communicating one or more audio channels of the first audio content to the one or more other playback devices over the wireless network using the second radio, detecting an event, and based on the event, switching a role of the first radio with a role of the second radio such that the connection to the at least one external device is transitioned from the first radio to the second radio and the wireless network is transitioned from the second radio to the first radio.

Example 57 includes the method of Example 56, further comprising receiving an instruction to form a bonded group that comprises the playback device and the one or more other playback devices, wherein establishing the wireless network is performed after receiving the instruction.

Example 58 includes the method of Example 57, further comprising: after switching a role of the first radio with a role of the second radio, (i) receiving second audio content, and (ii) communicating at least a portion of the second audio content to the one or more other playback devices over the wireless network using the first radio.

Example 59 includes the method of any one of Examples 56-59, wherein detecting the event includes detecting at least one of an instruction to change a source of the first audio content, an instruction to transition from playback of the first audio content to playback of second audio content, a change in one or channel conditions of the wireless network, a change in one or more channel conditions of the connection to the at least one external device, an instruction to form a bonded group with one or more satellite playback devices, or an instruction to add a satellite playback device to a bonded group including the playback device and at least one other satellite playback device.

Example 60 includes the method of any one of Examples 56-59, wherein establishing the connection comprises establishing a connection within any of a plurality of frequency ranges comprising: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 61 includes the method of Example 60, wherein establishing the wireless network includes: scanning at least some of the plurality of frequency ranges to select, from among the plurality of frequency ranges, a selected frequency range not occupied by the connection to the at least one external device, and establishing the wireless network using the selected frequency range.

Example 62 includes the method of any one of Examples 56-61, wherein switching the role of the first radio with the role of the second radio is performed without interrupting playback of the one or more audio channels of audio content by the one or more other playback devices.

Example 63 provides a playback device configured to implement the method of any one of Examples 56-62.

Example 64 provides a playback device comprising a wireless communication interface configured to facilitate communication over a plurality of frequency ranges, the wireless communication interface comprising a radio integrated circuit (IC) including a first radio and a second radio, wherein the wireless communication interface is configured to facilitate wireless communication via the first radio on only a first subset of the plurality of frequency ranges and facilitate communication via the second radio on only a second subset of the plurality of frequency ranges, wherein the first subset is different from the second subset. The playback device further comprises at least one processor, and at least one non-transitory computer-readable medium storing program instructions that are executable by the at least one processor such that the playback device is configured to: establish, using the first radio, a connection to at least one external device using a first frequency range selected from the first subset of the plurality of frequency ranges, detect an instruction to form a bonded group comprising the playback device and at least one satellite playback device, after detecting the instruction, establish a wireless network in a second frequency range selected from the second subset of the plurality of frequency ranges, the second frequency range being non-overlapping with the first frequency range, after the at least one satellite playback device has connected to the wireless network, (i) receive first audio content, and (ii) communicate one or more audio channels of the first audio content to the at least one satellite playback devices over the wireless network using the second radio, detect an event, and based on the event, switch a role of the first radio with a role of the second radio such that the connection to the at least one external device is transitioned from the first radio to the second radio and the wireless network is transitioned from the second radio to the first radio.

Example 65 includes the playback device of Example 64, wherein the at least one non-transitory computer-readable medium further stores program instructions that are executable by the at least one processor such that the playback device is configured to render at least one audio channel of the first audio content in synchrony with rendering of the one or more audio channels of the audio content by the at least one satellite playback device.

Example 66 includes the playback device of one of Examples 64 or 65, wherein the event includes at least one of an instruction to change a source of the first audio content, an instruction to transition from playback of the first audio content to playback of second audio content, a change in one or channel conditions of the wireless network, a change in one or more channel conditions of the connection to the at least one external device, an instruction to form a bonded group with one or more satellite playback devices, or an instruction to add a satellite playback device to a bonded group including the playback device and at least one other satellite playback device.

Example 67 includes the playback device of any one of Examples 64-66, wherein the at least one non-transitory computer-readable medium further stores program instructions that are executable by the at least one processor such that the playback device is configured to: after switching the role of the first radio with the role of the second radio, (i) receive second audio content, and (ii) communicate at least a portion of the second audio content to the at least one satellite playback device over the wireless network using the first radio.

Example 68 includes the playback device of any one of Examples 64-67, wherein the first subset includes at least one frequency range in common with the second subset.

Example 69 includes the playback device of any one of Examples 64-68, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 70 provides a playback device comprising at least one wireless communication interface configured to facilitate communication over a plurality of frequency ranges, the at least one wireless communication interface comprising a first radio and a second radio, and at least one processor. The playback device further comprises at least one non-transitory computer-readable medium storing program instructions that are executable by the at least one processor such that the playback device is configured to: establish, using the first radio, a connection to at least one external device using a wireless channel of operation within a first frequency range of the plurality of frequency ranges, detect an instruction to initiate playback of audio content by at least one other playback device, after detecting the instruction, scan the plurality of frequency ranges to identify a preferred frequency range from among the plurality of frequency ranges, based on the preferred frequency range being the first frequency range, transmit a request to the at least one external device to change the wireless channel of operation, based on a response from the at least one external device, establish, using the second radio, a wireless network within one of the first frequency range or another frequency range from among the plurality of frequency ranges, and after detecting that the at least one other playback device has connected to the wireless network, (i) receive audio content, and (ii) communicate one or more audio channels of the audio content to the at least one other playback device over the wireless network using the second radio.

Example 71 includes the playback device of Example 70, wherein to establish the wireless network, the at least one non-transitory computer-readable medium further stores program instructions that are executable by the at least one processor such that the playback device is configured to: based on the response from the at least one external device accepting the request to change the wireless channel of operation, change the wireless channel of operation to within a second frequency range from among the plurality of frequency ranges; and establish the wireless network within the first frequency range.

Example 72 includes the playback device of one of Examples 70 or 71, wherein to identify the preferred frequency range, the at least one non-transitory computer-readable medium further stores program instructions that are executable by the at least one processor such that the playback device is configured to identify the preferred frequency range and identify a next-preferred frequency range from among the plurality of frequency ranges.

Example 73 includes the playback device of Example 72, wherein to establish the wireless network, the at least one non-transitory computer-readable medium further stores program instructions that are executable by the at least one processor such that the playback device is configured to, based on the response from the at least one external device rejecting the request to change the wireless channel of operation, establish the wireless network within the next-preferred frequency range.

Example 74 includes the playback device of one of Examples 72 or 73, wherein each of the plurality of frequency ranges comprises a plurality of wireless channels.

Example 75 includes the playback device of Example 74, wherein to identify the preferred frequency range, the at least one non-transitory computer-readable medium further stores program instructions that are executable by the at least one processor such that the playback device is configured to identify the preferred frequency range and the next-preferred frequency range based on one or more channel parameters of at least some of the plurality of wireless channels within one or more of the plurality of frequency ranges and/or one or more characteristics of the at least one other playback device.

Example 76 includes the playback device of Example 75, wherein the one or more channel parameters include any of a measure of channel congestion, a measure of channel quality, or a channel latency metric, and wherein the one or more characteristics of the at least one other playback device include wireless protocols supported by the at least one other playback device.

Example 77 includes the playback device of any one of Examples 70-76, wherein the instruction to initiate playback of audio content by at least one other playback device includes an instruction to form a bonded group with the at least one other playback device, and wherein the at least one non-transitory computer-readable medium further stores program instructions that are executable by the at least one processor such that the playback device is configured to render at least one audio channel of the audio content in synchrony with rendering of the one or more audio channels of the audio content by the at least one other playback device.

Example 78 includes the playback device of Example 77, wherein the playback device is a soundbar.

Example 79 includes the playback device of any one of Examples 70-78, wherein the at least one non-transitory computer-readable medium further stores program instructions that are executable by the at least one processor such that the playback device is configured to:

detect an event, and based on the event, switch a role of the first radio with a role of the second radio such that the connection to the at least one external device is transitioned from the first radio to the second radio and the wireless network is transitioned from the second radio to the first radio.

Example 80 includes the playback device of Example 79, wherein the event includes at least one of an instruction to change a source of the audio content, an instruction to transition from playback of the audio content to playback of other audio content, a change in one or channel conditions of the wireless network, a change in one or more channel conditions of the wireless channel of operation, or an instruction to add a satellite playback device to a bonded group including the playback device and the at least one other playback device.

Example 81 includes the playback device of one of Examples 79 or 80, wherein the audio content is first audio content, and wherein at least one non-transitory computer-readable medium further stores program instructions that are executable by the at least one processor such that the playback device is configured to: after switching the role of the first radio with the role of the second radio, (i) receive second audio content, and (ii) communicate at least a portion of the second audio content to the at least one other playback device over the wireless network using the first radio.

Example 82 includes the playback device of any one of Examples 70-81, wherein the first and second radios are integrated into a single radio integrated circuit (IC).

Example 83 includes the playback device of any one of Examples 70-82, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 84 provides a method of operation for a playback device, the method comprising: establishing, using a first radio of the playback device, a connection to at least one external device using a wireless channel of operation within a first frequency range of a plurality of frequency ranges, detecting an instruction to initiate playback of audio content by at least one other playback device, after detecting the instruction, scanning the plurality of frequency ranges to identify a preferred frequency range from among the plurality of frequency ranges, based on the preferred frequency range being the first frequency range, transmitting, from the playback device, a request to the at least one external device to change the wireless channel of operation, based on a response from the at least one external device, establishing, using a second radio of the playback device, a wireless network within one of the first frequency range or another frequency range from among the plurality of frequency ranges, and after detecting that the at least one other playback device has connected to the wireless network, (i) receiving, at the playback device, audio content from the at least one external device using the first radio, and (ii) communicating, from the playback device, one or more audio channels of the audio content to the at least one other playback device over the wireless network using the second radio.

Example 85 includes the method of Example 84, wherein establishing the wireless network comprises: detecting that the response from the at least one external device includes accepting the request to change the wireless channel of operation, changing the wireless channel of operation to within a second frequency range from among the plurality of frequency ranges, and establishing the wireless network within the first frequency range.

Example 86 includes the method of one of Examples 84 or 85, wherein identifying the preferred frequency range comprises identifying the preferred frequency range and identifying a next-preferred frequency range from among the plurality of frequency ranges.

Example 87 includes the method of Example 86, wherein establishing the wireless network comprises detecting that the response from the at least one external device includes a rejection of the request to change the wireless channel of operation, and establishing the wireless network within the next-preferred frequency range.

Example 88 includes the method of one of Examples 86 or 87, wherein each of the plurality of frequency ranges comprises a plurality of wireless channels.

Example 89 includes the method of Example 88, wherein identifying the preferred frequency range comprises identifying the preferred frequency range and the next-preferred frequency range based on one or more channel parameters of at least some of the plurality of wireless channels within one or more of the plurality of frequency ranges and/or one or more characteristics of the at least one other playback device.

Example 90 includes the method of any one of Examples 84-89, wherein the plurality of frequency ranges comprises: a 2.4 Gigahertz (GHz) band in 802.11-based protocols, a first portion of a 5 GHz band in 802.11-based protocols, a second portion of the 5 GHz band in 802.11-based protocols that is non-overlapping with the first portion, and a 6 GHz band in 802.11-based protocols.

Example 91 includes the method of any one of Examples 84-90, further comprising detecting an event, and based on the event, switching a role of the first radio with a role of the second radio such that the connection to the at least one external device is transitioned from the first radio to the second radio and the wireless network is transitioned from the second radio to the first radio.

Example 92 includes the method of Example 91, wherein detecting the event comprises detecting at least one of: an instruction to change a source of the audio content, an instruction to transition from playback of the audio content to playback of other audio content, a change in one or channel conditions of the wireless network, a change in one or more channel conditions of the wireless channel of operation, or an instruction to add a satellite playback device to a bonded group including the playback device and the at least one other playback device.

Example 93 includes the method of Example 91, wherein the audio content is first audio content, the method further comprising after switching the role of the first radio with the role of the second radio, (i) receiving, at the playback device, second audio content, and (ii) communicating, from the playback device, at least a portion of the second audio content to the at least one other playback device over the wireless network using the first radio.

Example 94 includes the method of any one of Examples 84-93, wherein the instruction to initiate playback of audio content by at least one other playback device includes an instruction to form a bonded group with the at least one other playback device, and wherein the method further comprises rendering, with the playback device, at least one audio channel of the audio content in synchrony with rendering of the one or more audio channels of the audio content by the at least one other playback device.

Example 95 provides a playback device configured to implement the method of any one of Examples 84-94.

Example 96 provides a playback device comprising at least one wireless communication interface configured to facilitate communication over a plurality of frequency ranges, the at least one wireless communication interface comprising a first radio configured to operate in a plurality of first frequency ranges and a second radio configured to operate in a plurality of second frequency ranges, wherein the plurality of first frequency ranges and the plurality of second frequency ranges share at least one common frequency range, and wherein at least one of the plurality of second frequency ranges is a frequency range that is non-overlapping with any of the plurality of first frequency ranges. The playback device further comprises at least one processor, and at least one non-transitory computer-readable medium storing program instructions that are executable by the at least one processor such that the playback device is configured to: using the first radio, establish within a first frequency range selected from among the plurality of first frequency ranges, a wireless network for communication with one or more other playback devices, using the second radio, establish within a second frequency range selected from among the plurality of second frequency ranges, a connection to at least one external device, and transmit to the at least one external device, via the connection, at least one message informing the at least one external device that the first frequency range is occupied and unavailable for use by the at least one external device.

Example 97 includes the playback device of Example 96, wherein the at least one non-transitory computer-readable medium further stores program instructions that are executable by the at least one processor such that the playback device is configured to: during a playback session, receive, from the at least one external device via the connection, an audio stream representing audio content, and during the playback session, communicate one or more audio channels of the audio content to the one or more other playback devices over the wireless network using the second radio.

Example 98 includes the playback device of Example 97, wherein to transmit the at least one message, the at least one non-transitory computer-readable medium storing program instructions that are executable by the at least one processor such that the playback device is configured to: determine that the playback session is active, and transmit the at least one message based on the playback session being active.

Example 99 provides a method comprising: scanning a plurality of wireless channels within a plurality of frequency ranges for selection of an operating wireless channel, receiving a message containing a penalty value associated with at least one wireless channel of the plurality of wireless channels, the penalty value being based on an active playback session using the at least one wireless channel, calculating a channel score for each wireless channel to produce a plurality of channel scores, the channel score for each wireless channel being based on a plurality of factors including the penalty value, and selecting the operating wireless channel based the plurality of channel scores.

Example 100 provides a playback device configured to implement the method of Example 99.

Example 101 provides a method comprising: detecting, by an access point, a message communicating an initialization token from a playback device, authenticating, by the access point via an identity provider, the initialization token to establish the playback device as being a trusted playback device, communicating, by the access point, a response token to the trusted playback device, authenticating, by the trusted playback device, the response token to establish the access point as being a trusted access point, communicating, by the trusted access point to the trusted playback device, security credentials for accessing a wireless network provided by the access point, storing, by the trusted playback device, the security credentials, and joining, by the trusted playback device, the wireless network using the security credentials.

Example 102 provides a playback device comprising at least one processor, and a wireless communication interface comprising a plurality of antennas, a radio integrated circuit (IC) including a first radio and a second radio, each of the first and second radios configured to operate in a plurality of frequency ranges, and radio frequency (RF) front-end circuitry coupled to the radio IC and to the plurality of antennas, the RF front-end circuitry configured to selectively couple a respective one or more antennas of the plurality of antennas to each of the first and second radios to establish at least one first transceiver chain between the first radio and the respective one or more antennas and at least one second transceiver chain between the second radio and the respective one or more antennas, wherein the at least one first transceiver chain is configured for a first operating frequency range selected from the plurality of frequency ranges, wherein the at least one second transceiver chain is configured for a second operating frequency range selected from the plurality of frequency ranges, and wherein the first and second operating frequency ranges are non-overlapping. The playback device further comprises at least one non-transitory computer-readable storage medium coupled to the at least one processor and storing program instructions that are executable by the at least one processor to cause the playback device to, after receiving, via the first radio, audio content from an external device, transmit to at least one other playback device, via the second radio, data representing at least one audio channel of the audio content.

Example 103 includes the playback device of Example 102, wherein the program instructions include program instructions that are executable by the at least one processor to control selection of the second operating frequency range based at least in part on the first operating frequency range.

Example 104 includes the playback device of Example 103, wherein the RF front-end circuitry comprises a network of switches configured to selectively couple the respective one or more of the plurality of antennas to each of the first and second radios.

Example 105 includes the playback device of Example 104, wherein the RF front-end circuitry further comprises a plurality of bandpass filters, wherein the at least one first transceiver chain includes a first bandpass filter of the plurality of bandpass filters, the first bandpass filter configured to pass the first operating frequency range and suppress the second operating frequency range, and wherein the at least one first transceiver chain includes a second bandpass filter of the plurality of bandpass filters, the second bandpass filter configured to pass the second operating frequency range and suppress the first operating frequency range.

Example 106 includes the playback device of Example 105, wherein the network of switches includes one or more switches configured to selectively couple the first bandpass filter into the first transceiver chain and to selectively couple the second bandpass filter into the second transceiver chain.

Example 107 includes the playback device of Example 106, further comprising logic circuitry coupled to one or more input/output pins of the radio IC and to the network of switches, the logic circuitry configured to control operation of the network of switches.

Example 108 includes the playback device of any one of Examples 102-107, wherein each frequency range of the plurality of frequency ranges comprises a respective plurality of wireless channels.

Example 109 includes the playback device of any one of Examples 102-108, wherein the plurality of frequency ranges comprises: a first portion of a 5 GHz band in 802.11-based protocols, a second portion of the 5 GHz band in 802.11-based protocols that is non-overlapping with the first portion, and a 6 GHz band in 802.11-based protocols.

Example 110 includes the playback device of Example 109, wherein the first radio is configured to operate in at least one additional frequency range not supported by the second radio.

Example 111 includes the playback device of Example 110, wherein the at least one additional frequency range includes at least one of a 2.4 Gigahertz (GHz) band in 802.11-based protocols or a 2.4 GHz band in BLUETOOTH protocols.

Example 112 includes the playback device of any one of Examples 102-111, further comprising one or more speakers and one or more amplifiers coupled to the one or more speakers, wherein the program instructions include program instructions that are executable by the at least one processor to cause the playback device to render one or more audio channels of the audio content in synchrony with rendering of the at least one audio channel of the audio content by the at least one other playback device.

Example 113 provides a wireless communication interface for a playback device, the wireless communication interface comprising a radio integrated circuit (IC) including a first radio and a second radio, each of the first and second radios configured to support wireless communications in a plurality of frequency ranges, and radio frequency (RF) front-end circuitry coupled to the radio IC and configured to selectively couple each of the first and second radios to a respective antenna terminal to establish at least one first transceiver chain between the first radio and a first antenna terminal and at least one second transceiver chain between the second radio and a second antenna terminal, the RF front-end circuitry including a plurality of switches and a plurality of filters, wherein the at least one first transceiver chain is configured for a first operating frequency range selected from the plurality of frequency ranges, wherein the at least one second transceiver chain is configured for a second operating frequency range selected from the plurality of frequency ranges, and wherein the first and second operating frequency ranges are non-overlapping, wherein the plurality of frequency ranges comprises a first portion of a 5 GHz band in 802.11-based protocols, a second portion of the 5 GHz band in 802.11-based protocols that is non-overlapping with the first portion, and a 6 GHz band in 802.11-based protocols.

Example 114 includes the wireless communication interface of Example 113, wherein plurality of filters includes a first bandpass filter configured to pass the first operating frequency range and a second bandpass filter configured to pass the second operating frequency range, and wherein at least some switches of the plurality of switches are configured to selectively couple the first bandpass filter into the first transceiver chain and to selectively couple the second bandpass filter into the second transceiver chain.

Example 115 includes the wireless communication interface of one of Examples 113 or 114, wherein the first radio is configured to support wireless communications in at least one additional frequency range not supported by the second radio.

Example 116 includes the wireless communication interface of Example 115, wherein the at least one additional frequency range includes at least one of a 2.4 Gigahertz (GHz) band in 802.11-based protocols or a 2.4 GHz band in Bluetooth protocols.

Example 117 includes the wireless communication interface of any one of Examples 113-116, further comprising logic circuitry coupled to one or more input/output pins of the radio IC, the logic circuitry configured to control operation of the plurality of switches.

Example 118 includes the wireless communication interface of any one of Examples 113-117, further comprising a substrate, wherein the radio IC is mounted on the substrate.

Example 119 includes the wireless communication interface of Example 118, wherein the substrate is a printed circuit board.

Example 120 includes the wireless communication interface of Example 119, wherein at least a portion of the RF front-end circuitry is mounted on the printed circuit board.

Example 121 provides a wireless communication interface for a playback device, the wireless communication interface comprising a radio integrated circuit (IC) including a first radio and a second radio, each of the first and second radios configured to support wireless communications in a plurality of frequency ranges, and a plurality of bandpass filters, each bandpass filter configured to pass signals in a respective frequency range of the plurality of frequency ranges. The wireless communication interface further comprises a network of switches configured to selectively couple the first and second radios, via respective bandpass filters selected from the plurality of bandpass filters, to first and second antenna terminals, respectively, so as to establish a first transceiver chain between the first radio and the first antenna terminal and a second transceiver chain between the second radio and the second antenna terminal, wherein the first transceiver chain is configured to pass signals in a first operating frequency range, selected from the plurality of frequency ranges, between the first radio and the first antenna terminal, and the second transceiver chain is configured to pass signals in a second operating frequency range, selected from the plurality of frequency ranges, between the second radio and the second antenna terminal. The wireless communication interface further comprises control circuitry coupled to the radio IC and to the network of switches and configured to control operation of the network of switches to establish the first and second transceiver chains.

Example 122 includes the wireless communication interface of Example 121, further comprising a first front-end module coupled between the first radio and the network of switches, and a second front-end module coupled between the second radio and the network of switches.

Example 123 includes the wireless communication interface of Example 122, wherein the control circuitry comprises digital logic circuitry coupled between one or more input/output pins of the radio IC and a plurality of input/output pins of each of the first and second front-end modules.

Example 124 includes the wireless communication interface of one of Examples 122 or 123, further comprising a third front-end module coupled to the first radio, and a diplexer coupled between the third front-end module and one of the first antenna terminal or the second antenna terminal.

Example 125 includes the wireless communication interface of Example 124, wherein the plurality of frequency ranges comprises: a first portion of a 5 GHz band in 802.11-based protocols, a second portion of the 5 GHz band in 802.11-based protocols that is non-overlapping with the first portion, and a 6 GHz band in 802.11-based protocols.

Example 126 includes the wireless communication interface of Example 125, wherein the plurality of bandpass filters includes a first bandpass filter configured to pass signals in the first portion of the 5 GHz band, second and third bandpass filters configured to pass signals in the second portion of the 5 GHz band, and a fourth bandpass filter configured to pass signals in the 6 GHz band.

Example 127 includes the wireless communication interface of Example 126, wherein the control circuitry is configured to control the network of switches to select the second operating frequency range based at least in part on the first operating frequency range.

Example 128 includes the wireless communication interface of any one of Examples 121-126, further comprising a substrate, wherein the radio IC is mounted on the substrate.

Example 129 includes the wireless communication interface of Example 128, wherein the substrate is a printed circuit board.

Example 130 includes the wireless communication interface of Example 129, wherein the plurality of bandpass filters and the network of switches are disposed on the printed circuit board.

Example 131 includes the wireless communication interface of one of Examples 129 or 130, wherein the control circuitry is disposed on the printed circuit board.

Example 132 provides a wireless communication interface for a playback device, the wireless communication interface comprising a radio integrated circuit (IC) including a first radio and a second radio, each of the first and second radios configured to support wireless communications in a plurality of frequency ranges, a first antenna terminal, a second antenna terminal, and a plurality of bandpass filters, each bandpass filter configured to pass signals in a respective frequency range of the plurality of frequency ranges. The wireless communication interface further comprises a network of switches configured to selectively couple the first radio to one of the first antenna terminal or the second antenna terminal via one of the plurality of bandpass filters so as to establish a first transceiver chain configured to pass signals in a first operating frequency range to and from the first radio, the network of switches further configured to selectively couple the second radio to the other of the first antenna terminal or the second antenna terminal via another of the plurality of bandpass filters so as to establish a second transceiver chain configured to pass signals in a second operating frequency range to and from the second radio, wherein the first and second operating frequency ranges are selected from the plurality of frequency ranges and are non-overlapping, and control circuitry coupled to the radio IC and to the network of switches and configured to control operation of the network of switches to establish the first and second transceiver chains.

Example 133 includes the wireless communication interface of Example 132, wherein the network of switches comprises a first switch configured to selectively couple the first antenna terminal to any bandpass filter in a first subset of the plurality of bandpass filters, and a second switch configured to selectively couple the second antenna terminal to any bandpass filter in a second subset of the plurality of bandpass filters.

Example 134 includes the wireless communication interface of Example 133, wherein the network of switches further comprises a third switch coupled to the first subset of bandpass filters, a fourth switch coupled to the second subset of bandpass filters, a fifth switch configured to selectively couple the first radio to one of the third or fourth switches, and a sixth switch configured to selectively couple the second radio to one of the third or fourth switches.

Example 135 includes the wireless communication interface of Example 134, wherein each of the first and second subsets of bandpass filters includes two bandpass filters, and wherein the third and fourth switches are double-pole-double-throw switches.

Example 136 includes the wireless communication interface of any one of Examples 133-35, wherein the plurality of frequency ranges comprises: a first portion of a 5 GHz band in 802.11-based protocols, a second portion of the 5 GHz band in 802.11-based protocols that is non-overlapping with the first portion, and a 6 GHz band in 802.11-based protocols.

Example 137 includes the wireless communication interface of Example 136, wherein the first subset of bandpass filters includes a first bandpass filter configured to pass signals in the first portion of the 5 GHz band and a second bandpass filters configured to pass signals in the second portion of the 5 GHz band, and wherein the second subset of bandpass filters includes a third bandpass filter configured to pass signals in the second portion of the 5 GHz band and a fourth bandpass filter configured to pass signals in the 6 GHz band.

Example 138 includes the wireless communication interface of Example 137, wherein the first, second, fifth, and sixth switches are single-pole-double-throw switches.

Example 139 includes the wireless communication interface of any one of Examples 134-138, further comprising a diplexer coupled to the first radio, the first antenna terminal, and the first switch.

Example 140 includes the wireless communication interface of Example 139, further comprising a first front-end module coupled between the first radio and the fifth switch, a second front-end module coupled between the second radio and the sixth switch, and a third front-end module coupled between the first radio and the diplexer.

Example 141 includes the wireless communication interface of any one of Examples 132-140, wherein the control circuitry comprises digital logic circuitry coupled to one or more input/output pins of the radio IC.

Example 142 includes the wireless communication interface of any one of Examples 132-141, further comprising a substate, wherein the radio IC is mounted on the substrate.

Example 143 provides a playback device comprising the wireless communication interface of any one of Examples 132-142, at least one processor, and at least one non-transitory computer-readable storage medium coupled to the at least one processor and storing program instructions that are executable by the at least one processor to cause the playback device to, after receiving, via the first radio, audio content from an external device, transmit to at least one other playback device, via the second radio, data representing at least one audio channel of the audio content.

Example 144 includes the playback device of Example 143, further comprising one or more speakers and one or more amplifiers coupled to the one or more speakers, wherein the program instructions include program instructions that are executable by the at least one processor to cause the playback device to render one or more audio channels of the audio content in synchrony with rendering of the at least one audio channel of the audio content by the at least one other playback device.

Example 145 includes the playback device of Example 144, wherein the program instructions include program instructions that are executable by the at least one processor to operate the control circuitry to select the second operating frequency range based at least in part on the first operating frequency range.

Example 146 includes the playback device of Example 145, wherein the program instructions include program instructions that are executable by the at least one processor to operate the control circuitry to select the second operating frequency range further based on one or more characteristics of the at least one other playback device.

Example 147 provides a playback device comprising at least one wireless communication interface configured to facilitate communication over a plurality of frequency ranges, the at least one wireless communication interface comprising a first radio configured to operate in a plurality of first frequency ranges and a second radio configured to operate in a plurality of second frequency ranges, wherein the plurality of first frequency ranges and the plurality of second frequency ranges share at least one common frequency range, and wherein at least one of the plurality of second frequency ranges is a frequency range that is non-overlapping with any of the plurality of first frequency ranges. The playback device further comprises at least one processor, and at least one non-transitory computer-readable medium storing program instructions that are executable by the at least one processor such that the playback device is configured to: using the first radio, establish within a first frequency range selected from among the plurality of first frequency ranges, a wireless network for communication with one or more other playback devices, using the second radio, establish within a second frequency range selected from among the plurality of second frequency ranges, a connection to at least one external device, and detect an event, wherein execution of one or more operations based on the event includes switching a role of the first radio with a role of the second radio such that the connection to the at least one external device is transitioned from the first radio to the second radio and the wireless network is transitioned from the second radio to the first radio, and based on determining that a playback session, during which one or more audio channels of audio content are communicated from the playback device to the one or more other playback devices over the wireless network, is active, deny execution of the one or more operations.

Modifications are possible in the described examples, and other examples are possible within the scope of the claims.

1. A wireless communication interface for a playback device, the wireless communication interface comprising:
a radio integrated circuit (IC) including a first radio and a second radio, each of the first and second radios configured to support wireless communications in a plurality of frequency ranges; and
radio frequency (RF) front-end circuitry coupled to the radio IC and configured to selectively couple each of the first and second radios to a respective antenna terminal to establish at least one first transceiver chain between the first radio and a first antenna terminal and at least one second transceiver chain between the second radio and a second antenna terminal, wherein the at least one first transceiver chain is configured to pass signals in a first operating frequency range selected from the plurality of frequency ranges, wherein the at least one second transceiver chain is configured to pass signals in a second operating frequency range selected from the plurality of frequency ranges, and wherein the first and second operating frequency ranges are non-overlapping; and
wherein the plurality of frequency ranges comprises a first portion of a 5 GHz band in 802.11-based protocols, a second portion of the 5 GHz band in 802.11-based protocols that is non-overlapping with the first portion, and a 6 GHz band in 802.11-based protocols.

2. The wireless communication interface of claim 1, wherein the RF front-end circuitry comprises:
a plurality of bandpass filters including a first bandpass filter configured to pass the first operating frequency range of the plurality of frequency range and suppress the second operating frequency range, and a second configured to pass the second operating frequency range and suppress the first operating frequency range; and
a network of switches configured to selectively couple the first and second radios, via respective bandpass filters selected from the plurality of bandpass filters, to the first and second antenna terminals, respectively, so as to establish the first transceiver chain between the first radio and the first antenna terminal and the second transceiver chain between the second radio and the second antenna terminal;
wherein the network of switches includes one or more switches configured to selectively couple the first bandpass filter into the first transceiver chain and to selectively couple the second bandpass filter into the second transceiver chain.

3. (canceled)

4. (canceled)

5. The wireless communication interface of claim 2, further comprising control circuitry coupled to the radio IC and to the network of switches and configured to control operation of the network of switches to establish the at least one first transceiver chain and the at least one second transceiver chains.

6. (canceled)

7. The wireless communication interface claim 5, wherein the control circuitry is configured to control the network of switches to select the second operating frequency range based at least in part on the first operating frequency range.

8. The wireless communication interface of claim 2, further comprising:
a first front-end module coupled between the first radio and the network of switches;
a second front-end module coupled between the second radio and the network of switches;
a third front-end module coupled to the first radio; and
a diplexer coupled between the third front-end module and one of the first antenna terminal or the second antenna terminal.

9. (canceled)

10. The wireless communication interface of claim 8, wherein the network of switches comprises:
a first switch configured to selectively couple the first antenna terminal to any bandpass filter in a first subset of the plurality of bandpass filters, the first subset including the first bandpass filter and at least one other bandpass filter; and
a second switch configured to selectively couple the second antenna terminal to any bandpass filter in a second subset of the plurality of bandpass filters, the second subset including the second bandpass filter and at least one other bandpass filter.

11. The wireless communication interface of claim 10, wherein the network of switches further comprises:
a third switch coupled to the first subset of bandpass filters;
a fourth switch coupled to the second subset of bandpass filters;
a fifth switch configured to selectively couple the first radio to one of the third or fourth switches; and
a sixth switch configured to selectively couple the second radio to one of the third or fourth switches;
wherein the third and fourth switches are double-pole-double-throw switches.

12. (canceled)

13. (canceled)

14. The wireless communication interface of claim 11, wherein the first, second, fifth, and sixth switches are single-pole-double-throw switches;
wherein the first subset of the plurality of bandpass filters includes the first bandpass filter configured to pass signals in the first portion of the 5 GHz band and a third bandpass filter configured to pass signals in the second portion of the 5 GHz band; and
wherein the second subset of the plurality of bandpass filters includes the second bandpass filter configured to pass signals in the second portion of the 5 GHz band and a fourth bandpass filter configured to pass signals in the 6 GHz band.

15. (canceled)

16. The wireless communication interface of claim 11, further comprising:
a diplexer coupled to the first radio, the first antenna terminal, and the first switch;
a first front-end module coupled between the first radio and the fifth switch;
a second front-end module coupled between the second radio and the sixth switch; and
a third front-end module coupled between the first radio and the diplexer.

17. (canceled)

18. (canceled)

19. The wireless communication interface of claim 2, wherein the first radio is configured to support wireless communications in at least one additional frequency range not supported by the second radio; and
wherein the at least one additional frequency range includes at least one of a 2.4 Gigahertz (GHz) band in 802.11-based protocols or a 2.4 GHz band in Bluetooth protocols.

20-75. (canceled)

76. A playback device comprising:
at least one processor;
one or more speakers; and
one or more amplifiers coupled to the one or more speakers;
a wireless communication interface comprising
a plurality of antennas,
a radio integrated circuit (IC) including a first radio and a second radio, each of the first and second radios configured to operate in a plurality of frequency ranges, and
radio frequency (RF) front-end circuitry coupled to the radio IC and to the plurality of antennas, the RF front-end circuitry configured to selectively couple a respective one or more antennas of the plurality of antennas to each of the first and second radios to establish at least one first transceiver chain between the first radio and the respective one or more antennas and at least one second transceiver chain between the second radio and the respective one or more antennas, wherein the at least one first transceiver chain is configured for a first operating frequency range selected from the plurality of frequency ranges, wherein the at least one second transceiver chain is configured for a second operating frequency range selected from the plurality of frequency ranges, and wherein the first and second operating frequency ranges are non-overlapping; and
at least one non-transitory computer-readable storage medium coupled to the at least one processor and storing program instructions that are executable by the at least one processor to cause the playback device to
after receiving, via the first radio, audio content from an external device, transmit to at least one other playback device, via the second radio, data representing at least one audio channel of the audio content, and
render one or more audio channels of the audio content in synchrony with rendering of the at least one audio channel of the audio content by the at least one other playback device.

77. The playback device of claim 76, wherein the program instructions include program instructions that are executable by the at least one processor to control selection of the second operating frequency range based at least in part on the first operating frequency range.

78. The playback device of claim 77, wherein the RF front-end circuitry comprises:
a network of switches configured to selectively couple the respective one or more of the plurality of antennas to each of the first and second radios; and
a plurality of bandpass filters;
wherein the at least one first transceiver chain includes a first bandpass filter of the plurality of bandpass filters, the first bandpass filter configured to pass the first operating frequency range and suppress the second operating frequency range;
wherein the at least one first transceiver chain includes a second bandpass filter of the plurality of bandpass filters, the second bandpass filter configured to pass the second operating frequency range and suppress the first operating frequency range; and
wherein the network of switches includes one or more switches configured to selectively couple the first bandpass filter into the first transceiver chain and to selectively couple the second bandpass filter into the second transceiver chain.

79. The playback device of claim 78, further comprising:
logic circuitry coupled to one or more input/output pins of the radio IC and to the network of switches, the logic circuitry configured to control operation of the network of switches.

80. The playback device of claim 1, wherein the plurality of frequency ranges comprises: a first portion of a 5 GHz band in 802.11-based protocols, a second portion of the 5 GHz band in 802.11-based protocols that is non-overlapping with the first portion, and a 6 GHz band in 802.11-based protocols.

81. The playback device of claim 80, wherein the first radio is configured to operate in at least one additional frequency range not supported by the second radio; and
wherein the at least one additional frequency range includes at least one of a 2.4 Gigahertz (GHz) band in 802.11-based protocols or a 2.4 GHz band in BLUETOOTH protocols.

82. A wireless communication interface for a playback device, the wireless communication interface comprising:
a radio integrated circuit (IC) including a first radio and a second radio, each of the first and second radios configured to support wireless communications in a plurality of frequency ranges;
a plurality of bandpass filters, each bandpass filter configured to pass signals in a respective frequency range of the plurality of frequency ranges;
a network of switches configured to selectively couple the first and second radios, via respective bandpass filters selected from the plurality of bandpass filters, to first and second antenna terminals, respectively, so as to establish a first transceiver chain between the first radio and the first antenna terminal and a second transceiver chain between the second radio and the second antenna terminal, wherein the first transceiver chain is configured to pass signals in a first operating frequency range, selected from the plurality of frequency ranges, between the first radio and the first antenna terminal, and the second transceiver chain is configured to pass signals in a second operating frequency range, selected from the plurality of frequency ranges, between the second radio and the second antenna terminal; and
control circuitry coupled to the radio IC and to the network of switches and configured to control operation of the network of switches to establish the first and second transceiver chains.

83. The wireless communication interface of claim 82, further comprising:
a first front-end module coupled between the first radio and the network of switches; and
a second front-end module coupled between the second radio and the network of switches;
wherein the control circuitry comprises digital logic circuitry coupled between one or more input/output pins of the radio IC and a plurality of input/output pins of each of the first and second front-end modules.

84. The wireless communication interface of claim 83, wherein the plurality of frequency ranges comprises: a first portion of a 5 GHz band in 802.11-based protocols, a second portion of the 5 GHz band in 802.11-based protocols that is non-overlapping with the first portion, and a 6 GHz band in 802.11-based protocols.

85. The wireless communication interface of claim 84, wherein the plurality of bandpass filters includes a first bandpass filter configured to pass signals in the first portion of the 5 GHz band, second and third bandpass filters configured to pass signals in the second portion of the 5 GHz band, and a fourth bandpass filter configured to pass signals in the 6 GHz band; and
wherein the control circuitry is configured to control the network of switches to select the second operating frequency range based at least in part on the first operating frequency range.
